(19) United States
(12) Patent Application Publication
(10) Pub. No.: US 2026/0150006 A1
(43) Pub. Date: May 28, 2026

(54) MITIGATING JITTER IN UPLINK COMMUNICATIONS

(71) Applicant: QUALCOMM Incorporated, San Diego, CA (US)

(72) Inventors: Hyun Yong LEE, San Diego, CA (US); Peerapol TINNAKORNSRISUPHAP, San Diego, CA (US); Prashanth Haridas HANDE, San Diego, CA (US); Ravi AGARWAL, San Diego, CA (US); Mickael MONDET, Louannec (FR); Diana MAAMARI, San Diego, CA (US)

(21) Appl. No.: 18/963,191

(22) Filed: Nov. 27, 2024

(51) Int. Cl. H04W 28/14; H04L 43/087; H04W 28/02

(52) U.S. Cl. CPC H04W 28/14; H04L 43/087; H04W 28/0236

(57) ABSTRACT

Methods, systems, and devices for wireless communications are described. A wireless device may generate one or more packet data unit (PDU) sets of a first periodic burst transmission during a jitter window, the first periodic burst transmission corresponding to a first delivery deadline at an application server (AS), the jitter window spanning a time period prior to or after a first arrival time associated with the one or more PDU sets. The wireless device may buffer the one or more PDU sets for a first duration of the jitter window, where the first duration corresponds to a threshold percentage of the jitter window. The wireless device may output the one or more PDU sets based on expiration of the first duration and prior to the first delivery deadline.

### FIELD OF TECHNOLOGY

The following relates to wireless communications, including mitigating jitter in uplink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a wireless device is described. The method may include generating one or more packet data unit (PDU) sets of a first periodic burst transmission during a jitter window, the first periodic burst transmission corresponding to a first delivery deadline at an application server (AS), the jitter window spanning a time period prior to or after a first arrival time associated with the one or more PDU sets, buffing the one or more PDU sets for a first duration of the jitter window, where the first duration corresponds to a threshold percentage of the jitter window, and outputting the one or more PDU sets based on expiration of the first duration and prior to the first delivery deadline.

A wireless device is described. The wireless device may include one or more memories storing processor executable code, and one or more processors coupled with the one or more memories. The one or more processors may individually or collectively be operable to execute the code to cause the wireless device to generate one or more PDU sets of a first periodic burst transmission during a jitter window, the first periodic burst transmission corresponding to a first delivery deadline at an AS, the jitter window spanning a time period prior to or after a first arrival time associated with the one or more PDU sets, buffer the one or more PDU sets for a first duration of the jitter window, where the first duration corresponds to a threshold percentage of the jitter window, and output the one or more PDU sets based on expiration of the first duration and prior to the first delivery deadline.

Another wireless device is described. The wireless device may include means for generating one or more PDU sets of a first periodic burst transmission during a jitter window, the first periodic burst transmission corresponding to a first delivery deadline at an AS, the jitter window spanning a time period prior to or after a first arrival time associated with the one or more PDU sets, means for buffing the one or more PDU sets for a first duration of the jitter window, where the first duration corresponds to a threshold percentage of the jitter window, and means for outputting the one or more PDU sets based on expiration of the first duration and prior to the first delivery deadline.

A non-transitory computer-readable medium storing code is described. The code may include instructions executable by one or more processors to generate one or more PDU sets of a first periodic burst transmission during a jitter window, the first periodic burst transmission corresponding to a first delivery deadline at an AS, the jitter window spanning a time period prior to or after a first arrival time associated with the one or more PDU sets, buffer the one or more PDU sets for a first duration of the jitter window, where the first duration corresponds to a threshold percentage of the jitter window, and output the one or more PDU sets based on expiration of the first duration and prior to the first delivery deadline.

Some examples of the method, wireless devices, and non-transitory computer-readable medium described herein may further include operations, features, means, or instructions for obtaining an indication that a set of periodic burst transmissions associated with a data flow may be consumed by the AS at a set of periodic delivery deadlines, the set of periodic burst transmissions including the first periodic burst transmission, and the set of periodic delivery deadlines including the first delivery deadline.

Some examples of the method, wireless devices, and non-transitory computer-readable medium described herein may further include operations, features, means, or instructions for outputting an indication of the jitter window and an indication of a burst arrival time associated with the first periodic burst transmission.

Some examples of the method, wireless devices, and non-transitory computer-readable medium described herein may further include operations, features, means, or instructions for estimating the jitter window associated with the first periodic burst transmission based on a reference table and communication conditions.

Some examples of the method, wireless devices, and non-transitory computer-readable medium described herein may further include operations, features, means, or instructions for measuring a set of multiple jitter windows and a corresponding set of multiple communication conditions associated with communication of a set of multiple periodic burst transmissions, the set of multiple periodic burst transmissions being prior to the first periodic burst transmission, where the reference table may be based on the set of multiple jitter windows and the corresponding set of multiple communication conditions.

Some examples of the method, wireless devices, and non-transitory computer-readable medium described herein may further include operations, features, means, or instructions for measuring one or more jitter windows associated with communication of one or more additional periodic burst transmissions and one or more communication conditions associated with the communication of the one or more additional periodic burst transmissions, the one or more additional periodic burst transmissions being after the set of multiple periodic burst transmissions and updating the reference table based on measuring the one or more jitter windows and the one or more communication conditions, where estimating the jitter window may be based on updating the reference table.

In some examples of the method, wireless devices, and non-transitory computer-readable medium described herein, the communication conditions includes an operating condition of the AS, a data rate of the first periodic burst transmission, a periodicity associated with the first periodic burst transmission, or any combination thereof.

Some examples of the method, wireless devices, and non-transitory computer-readable medium described herein may further include operations, features, means, or instructions for measuring a duration associated with generating the one or more PDU sets of the first periodic burst transmission and estimating the jitter window based on the duration associated with generating the one or more PDU sets.

Some examples of the method, wireless devices, and non-transitory computer-readable medium described herein may further include operations, features, means, or instructions for measuring one or more jitter windows associated with communication of one or more periodic burst transmissions, the one or more periodic burst transmissions being prior to the first periodic burst transmission, measuring a duration associated with generating the one or more PDU sets of the first periodic burst transmission, and estimating the jitter window based on the duration associated with generating the one or more PDU sets, a reference table, and communication conditions.

Some examples of the method, wireless devices, and non-transitory computer-readable medium described herein may further include operations, features, means, or instructions for starting a timer in response to obtaining the one or more PDU sets, the timer being set to the first duration, where buffering the one or more PDU sets may be based on starting the timer, and where outputting the first periodic burst transmission may be based on expiration of the timer.

Some examples of the method, wireless devices, and non-transitory computer-readable medium described herein may further include operations, features, means, or instructions for identifying a start time associated with the one or more PDU sets in response to obtaining the one or more PDU sets and delaying the one or more PDU sets from the start time for the first duration, where outputting the one or more PDU sets may be based on the expiration of the first duration.

A method by a user equipment (UE) is described. The method may include obtaining one or more PDU sets of a first periodic burst transmission during a jitter window, the first periodic burst transmission corresponding to a first delivery deadline at an AS, the jitter window spanning a time period prior to or after a first arrival time associated with the one or more PDU sets, buffing the one or more PDU sets for a first duration of the jitter window, where the first duration corresponds to a threshold percentage of the jitter window, and outputting the first periodic burst transmission based on expiration of the first duration and prior to the first delivery deadline.

A UE is described. The UE may include one or more memories storing processor executable code, and one or more processors coupled with the one or more memories. The one or more processors may individually or collectively be operable to execute the code to cause the UE to obtain one or more PDU sets of a first periodic burst transmission during a jitter window, the first periodic burst transmission corresponding to a first delivery deadline at an AS, the jitter window spanning a time period prior to or after a first arrival time associated with the one or more PDU sets, buffer the one or more PDU sets for a first duration of the jitter window, where the first duration corresponds to a threshold percentage of the jitter window, and output the first periodic burst transmission based on expiration of the first duration and prior to the first delivery deadline.

Another UE is described. The UE may include means for obtaining one or more PDU sets of a first periodic burst transmission during a jitter window, the first periodic burst transmission corresponding to a first delivery deadline at an AS, the jitter window spanning a time period prior to or after a first arrival time associated with the one or more PDU sets, means for buffing the one or more PDU sets for a first duration of the jitter window, where the first duration corresponds to a threshold percentage of the jitter window, and means for outputting the first periodic burst transmission based on expiration of the first duration and prior to the first delivery deadline.

A non-transitory computer-readable medium storing code is described. The code may include instructions executable by one or more processors to obtain one or more PDU sets of a first periodic burst transmission during a jitter window, the first periodic burst transmission corresponding to a first delivery deadline at an AS, the jitter window spanning a time period prior to or after a first arrival time associated with the one or more PDU sets, buffer the one or more PDU sets for a first duration of the jitter window, where the first duration corresponds to a threshold percentage of the jitter window, and output the first periodic burst transmission based on expiration of the first duration and prior to the first delivery deadline.

Some examples of the method, UEs, and non-transitory computer-readable medium described herein may further include operations, features, means, or instructions for obtaining an indication that a set of periodic burst transmissions associated with a data flow may be consumed by the AS at a set of periodic delivery deadlines, the set of periodic burst transmissions including the first periodic burst transmission, and the set of periodic delivery deadlines including the first delivery deadline.

Some examples of the method, UEs, and non-transitory computer-readable medium described herein may further include operations, features, means, or instructions for outputting an indication of the jitter window and an indication of a burst arrival time associated with the first periodic burst transmission and obtaining a configured grant based on the jitter window and the burst arrival time, where outputting the first periodic burst transmission may be based on the configured grant.

Some examples of the method, UEs, and non-transitory computer-readable medium described herein may further include operations, features, means, or instructions for outputting an indication of a delay status report (DSR) value associated with the first periodic burst transmission, where the DSR value indicates the one or more PDU sets arrived at a transmission buffer of the UE after buffering the one or more PDU sets.

Some examples of the method, UEs, and non-transitory computer-readable medium described herein may further include operations, features, means, or instructions for estimating the jitter window associated with the first periodic burst transmission based on a reference table and communication conditions.

Some examples of the method, UEs, and non-transitory computer-readable medium described herein may further include operations, features, means, or instructions for measuring a set of multiple jitter windows and a corresponding set of multiple communication conditions associated with communication of a set of multiple periodic burst transmissions, the set of multiple periodic burst transmissions being prior to the first periodic burst transmission, where the reference table may be based on the set of multiple jitter windows and the corresponding set of multiple communication conditions.

Some examples of the method, UEs, and non-transitory computer-readable medium described herein may further include operations, features, means, or instructions for measuring a duration associated with generating the one or more PDU sets of the first periodic burst transmission and estimating the jitter window based on the duration associated with generating the one or more PDU sets.

Some examples of the method, UEs, and non-transitory computer-readable medium described herein may further include operations, features, means, or instructions for measuring one or more jitter windows associated with communication of one or more periodic burst transmissions, the one or more periodic burst transmissions being prior to the first periodic burst transmission, measuring a duration associated with generating the one or more PDU sets of the first periodic burst transmission, and estimating the jitter window based on the duration associated with generating the one or more PDU sets, a reference table, and communication conditions.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports mitigating jitter in uplink communications in accordance with one or more aspects of the present disclosure.

FIG. 2 shows an example of a wireless communications system that supports mitigating jitter in uplink communications in accordance with one or more aspects of the present disclosure.

FIG. 3 shows an example of a timing diagram that supports mitigating jitter in uplink communications in accordance with one or more aspects of the present disclosure.

FIG. 4 shows an example of a timing diagram that supports mitigating jitter in uplink communications in accordance with one or more aspects of the present disclosure.

FIG. 5 shows an example of a process flow that supports mitigating jitter in uplink communications in accordance with one or more aspects of the present disclosure.

FIG. 6A shows an example of a buffering diagram that supports mitigating jitter in uplink communications in accordance with one or more aspects of the present disclosure.

FIG. 6B shows an example of a buffering diagram that supports mitigating jitter in uplink communications in accordance with one or more aspects of the present disclosure.

FIG. 7 shows an example of a process flow that supports mitigating jitter in uplink communications in accordance with one or more aspects of the present disclosure.

FIGS. 8 and 9 show block diagrams of devices that support mitigating jitter in uplink communications in accordance with one or more aspects of the present disclosure.

FIG. 10 shows a block diagram of a communications manager that supports mitigating jitter in uplink communications in accordance with one or more aspects of the present disclosure.

FIG. 11 shows a diagram of a system including a device that supports mitigating jitter in uplink communications in accordance with one or more aspects of the present disclosure.

FIGS. 12 and 13 show block diagrams of devices that support mitigating jitter in uplink communications in accordance with one or more aspects of the present disclosure.

FIG. 14 shows a block diagram of a communications manager that supports mitigating jitter in uplink communications in accordance with one or more aspects of the present disclosure.

FIG. 15 shows a diagram of a system including a device that supports mitigating jitter in uplink communications in accordance with one or more aspects of the present disclosure.

FIGS. 16 through 20 show flowcharts illustrating methods that support mitigating jitter in uplink communications in accordance with one or more aspects of the present disclosure.

### DETAILED DESCRIPTION

In some wireless communications systems, a user equipment (UE) may support extended reality (XR) communications. While operating an XR application client (AC) (e.g., application processor), the UE may communicate with an application server (AS) of a network. For example, the UE may transmit a periodic burst transmission including one or more packet data unit (PDU) sets to the AS. The periodic burst transmission may include a camera frame captured and encoded by the UE or AC. The AS may generate an XR video frame based on the camera data or camera frames. Accordingly, in response to generating the periodic burst transmission, the UE may transmit the periodic burst transmission to a radio access network (RAN) of the network. The RAN may proceed to forward, via a user plane function (UPF), the periodic burst transmission to the AS that is serving the UE.

In some implementations, camera frame generation at the AC may be associated with a jitter window (e.g., a time period during which a periodic burst transmission may be encoded and ready to transmit). The jitter window may span a time period prior to and after an average arrival time associated with multiple periodic burst transmissions or multiple PDUs within a periodic burst transmission (e.g., a minimum time period from the average arrival time and a maximum time period from the average arrival time). In such cases, however, if the jitter window spans a relatively large time period, the RAN may establish multiple configured grants to provide uplink resources to the UE throughout the duration of the jitter window, thereby reducing communication efficiency between the UE and the RAN. Thus, it may be desirable to reduce the effects of jitter during communications.

According to the techniques described herein, a UE (e.g., an AC or a UE modem of the UE) may buffer the periodic burst transmission (e.g., one or more PDU sets) for a threshold percentage of the jitter window in order to mitigate the effects of the jitter during the communications, thereby enabling the RAN to configure a reduced quantity of configured grants increasing communication efficiency. For example, the AC may generate one or more PDU sets of a first periodic burst transmission, where the first periodic burst transmission may be associated with a first delivery deadline at the UE during a jitter window. Accordingly, in some examples, the UE may buffer at least a portion of the one or more PDU sets for a first duration of the jitter window, where the first duration corresponds to a threshold percentage (e.g., 90%, 99%, 100%) of the jitter window. That is, the UE or the AC may delay at least a portion of the one or more PDU sets (e.g., one or more PDU sets generated prior to a threshold time) such that the first periodic burst transmission may be transmitted via a configured grant provided by the RAN.

The RAN may establish a reduced quantity of configured grants to provide uplink resources for the buffered periodic burst transmission. For example, the RAN may not establish a configured grant until the periodic burst transmission has been buffered for the threshold percentage of the jitter window. The reduced quantity of configured grants may increase communication efficiency between the UE and the RAN. Additionally, or alternatively, by establishing the reduced quantity of configured grants, the UE may reduce a quantity of uplink data (e.g., dummy packets) transmitted via configured grants not used to transmit the buffered periodic burst transmission, decreasing power consumption at the UE.

Aspects of the disclosure are initially described in the context of wireless communications systems. Additional aspects of the disclosure are described in the context of communications timelines, process flows, and buffering diagrams. Aspects of the disclosure are further illustrated by and described with reference to apparatus diagrams, system diagrams, and flowcharts that relate to mitigating jitter in uplink communications.

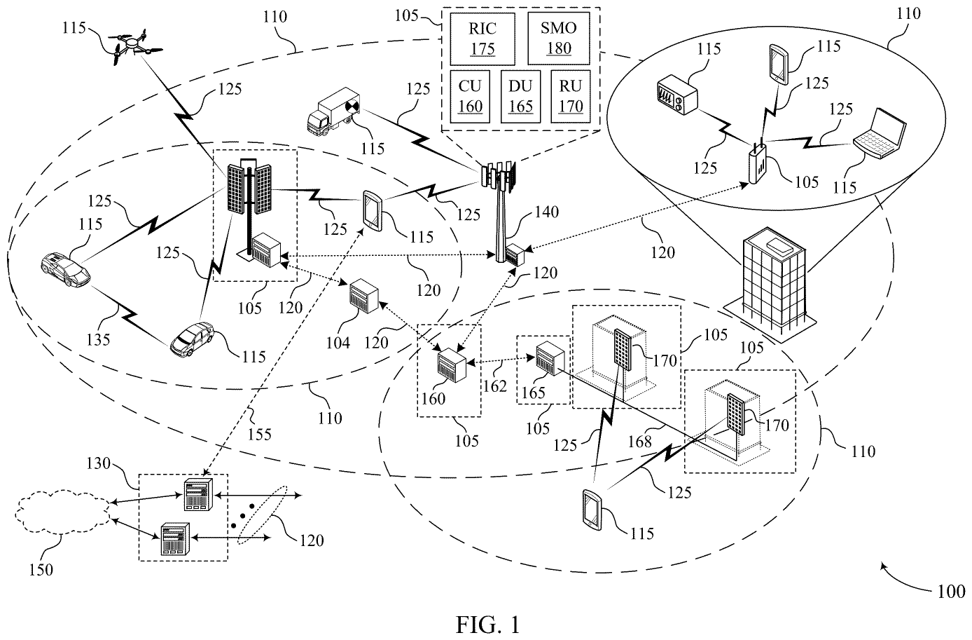

FIG. 1 shows an example of a wireless communications system 100 that supports mitigating jitter in uplink communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some implementations, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some implementations, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support mitigating jitter in uplink communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a UPF). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UE 115 may transmit user assistance information (UAI) to a RAN (e.g., the network entity 105) to provide uplink traffic information to the network entity 105 or the RAN (e.g., for uplink traffic information). The UE 115 may measure or be aware of more accurate or updated uplink traffic information compared to the network entity 105 or the RAN. For RAN resource preparation, the UE115 may report the uplink traffic information to RAN including: an arrival time, a periodicity, or a jitter. The arrival time (e.g., burstArivelTime-r18) may indicate an average value of the arrival time of the first packet of a data burst for a quality of service (QoS) flow. The periodicity of the data burst (e.g., trafficPeriodicity-r18) may indicate an expected periodicity of the data burst. The jitter (e.g., JitterRange-r18) may include a lower bound (e.g., lowerBound-r18) and an upper bound (e.g., upperBound-r18) associated with the jitter of the data burst. The RAN may configure configured grant resources based on the UAI report from the UE 115.

The RAN may grant periodic uplink resources to the UE 115 (e.g., without a scheduling request procedure or a buffer status report procedure). Granting the periodic uplink resources to the UE 115 may reduce the latency associate with uplink communication between the UE 115 and the RAN.

The UE 115 may transmit a delay status report (DSR) to the RAN (e.g., the network entity 105). The RAN may not know when the uplink traffic arrives at a transmission buffer of the UE 115. The UE 115 provides a serving network entity with a delay status of logical channel groups (LCGs) via the DSR (e.g., the DSR MAC control element (MAC-CE)). The DSR may include a LCG field, a remaining time field, a BSR table (BT) field, and a buffer size field. A LCG field (e.g., LCGi) may indicate a presence of delay information for the LCG i. A remaining time field may indicate a shortest remaining value of a PDCP discard timer. A BT field may be present if a corresponding LCG (e.g., LCG i) is configured to allow additional BT (e.g., configured with additionalBSR-TableAllowed). A buffer size field may indicate a total amount of delay-critical uplink data for an LCG.

According to the techniques described herein, a UE 115 (e.g., an AC or a UE modem of the UE 115) may buffer the periodic burst transmission (e.g., one or more PDU sets) for a threshold percentage of the jitter window in order to mitigate the effects of the jitter during the communications, thereby enabling a RAN (e.g., the network entity 105) to configure a reduced quantity of configured grants increasing communication efficiency. For example, the AC may generate one or more PDU sets of a first periodic burst transmission, where the first periodic burst transmission may be associated with a first delivery deadline at the UE 115 during a jitter window. Accordingly, in some examples, the UE 115 may buffer at least a portion of the one or more PDU sets for a first duration of the jitter window, where the first duration corresponds to a threshold percentage (e.g., 90%, 99%, 100%) of the jitter window. That is, the UE 115 or the AC may delay at least a portion of the one or more PDU sets (e.g., one or more PDU sets generated prior to a threshold time) such that the first periodic burst transmission may be transmitted via a configured grant provided by the RAN.

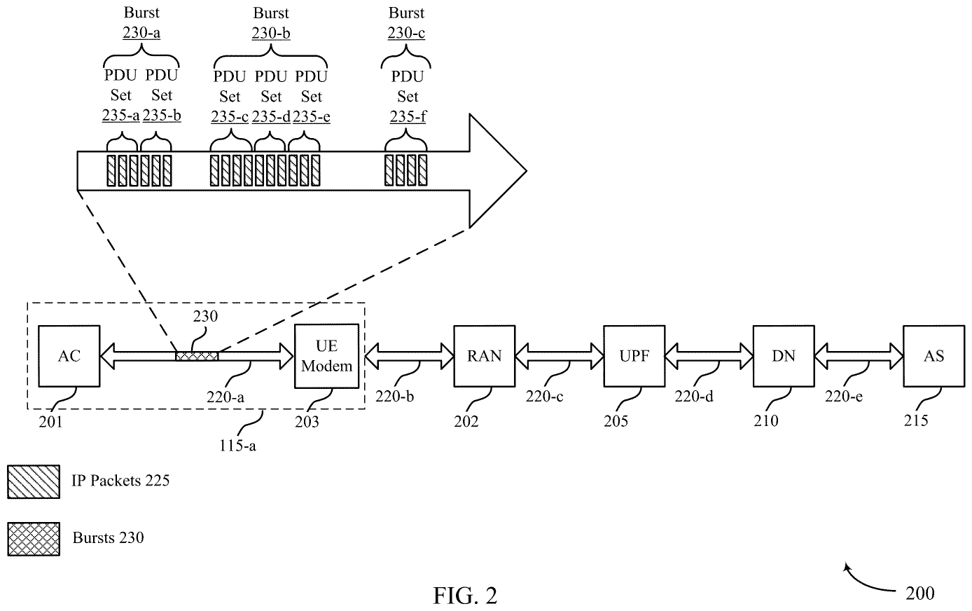

FIG. 2 shows an example of a wireless communications system 200 that supports mitigating jitter in uplink communications in accordance with one or more aspects of the present disclosure. For example, the wireless communications system 200 may include a UE 115-a, which may be an example of a UE 115, as described with reference to FIG. 1. In some implementations, the UE 115-b may include an AC 201 and a UE modem 203. In some implementations, the AC 201 and the UE modem 203 may be included in separate wireless devices. The wireless communications system 200 may also include a RAN 202, which may be an example of a network entity 105, described with reference to FIG. 1. The wireless communications system 200 may also include a UPF 205, a data network (DN) 210, and an AS 215 (e.g., an edge cloud server), which may be examples of corresponding entities operating in a core network 130, as described with reference to FIG. 1. The techniques described in the context of the wireless communications system 200 may enable the UE 115-a or the AC 201 to delay or buffer one or more bursts 230 or one or more PDU sets 235 of a burst 230 (e.g., periodic burst transmissions), thereby mitigating the effects of jitter during XR camera frame generation.

The AC 201 may use one or more cameras (e.g., tracking cameras or red-green-blue (RGB) cameras) to capture camera data for perception processing. The camera data may include a three-dimensional reconstruction of an environment, hand tacking data, image tracking data, or object tracking data. The AC 201 may offload video rendering to the AS 215. For example, the AC 201 may output a camera frame including the camera data to the UE modem 203, and the UE modem 203 may output the camera frame (e.g., via the RAN 202) to the AS 215. The AS 215 may generate and output video traffic of a rendering based on the camera frame, and the AC 201 may obtain and display the video traffic of the rendering to a user.

Uplink traffic (e.g., traffic from the AC 201 to the AS 215) may be video traffic of perception cameras (e.g., a camera frame), and downlink traffic (e.g., traffic from the AS 215 to the AC 201) may be video traffic of a rendering (e.g., a video frame). For uplink traffic, camera frames may be delivered to the AS 215 (e.g., the cloud) for perception processing offloading (e.g., three-dimensional (3D) recording (3DR), information technology and operation technology (IT/OT)). To reduce the uplink traffic, the camera frames may be encoded by a video codec (e.g., H.264 or high efficiency video coding (HEVC)).

XR traffic may be quasi-periodic (e.g., at an XR periodicity) based on jitter associated with frame generation and communication. For example, The AC 201 may output camera frames quasi-periodically, and a burst arrival time (BAT) of a camera frame at the AS 215 may be quasi-periodic (e.g., periodic with jitter). The AS 215 may perform video encoding and video encoding times may vary according to different complexity (e.g., IPPP frame pattern or scene complexity).

The range of jitter be relatively large compared to the XR periodicity (e.g., the jitter may be 48% of the XR periodicity, such as jitter=8 milliseconds (ms) compared to periodicity=16.666 ms (60 frames per second (fps))). The jitter may waste uplink resources (e.g., multiple configured grants), and the jitter may degrade the power consumption at the UE 115-a. XR system performance may suffer based on the jitter. According to techniques described herein, an efficient algorithm may minimize the performance degradation of the jitter for uplink traffic. Additionally, or alternatively, a UE 115 (e.g., including an AC 201 and a UE modem 203) may performing signaling such as a UAI for uplink traffic information and DSR, as described with reference to FIG. 1.

Jitter in uplink XR traffic may be based on varying burst generation times at the AC 201. For example, the burst generation time may be based on a processing time (e.g., camera operation and rendering time), an encoding time (e.g., encoding camera data into I/P/B frames), or an real-time transport protocol (RTP) packetization time. The processing time, the encoding time, and the RTP packetization time may vary between periodic bursts transmissions or PDU sets within a periodic burst transmission. In some examples, the burst generation times may fall within a jitter window spanning a time period prior to and after an average arrival time associated with multiple burst generation times. In some examples, the PDU set generation times may fall within a jitter window spanning a time period prior to and after an average arrival time associated with multiple PDU sets in a periodic burst transmission. For example, a jitter distribution for multiple burst generation times within a jitter window may span a duration (e.g., 10 ms) including the multiple burst generation times.

The jitter distribution may be modeled according to a truncated gaussian distribution (e.g., a Gaussian distribution with mean: 0 ms, standard deviation (STD): 2 ms), where, as an illustrative example, the jitter window may be a range of [−4,4] ms or [−5,5] ms centered around an average arrival time for the periodic burst transmission. For XR applications, the jitter window may be relatively large, as compared to other communication flows for other types of data or applications. For example, the range of jitter may use 48% of an XR message periodicity (e.g., jitter=8 ms vs. XR periodicity=16.666 ms (60 fps)).

In some examples, the AC 201 may communicate, to the AS 215, data associated with an XR application operating at the AC 201. In such examples, the XR application may consume (e.g., transmit or receive) data in one or more PDU sets 235 of a burst 230 (e.g., periodic burst transmission) rather than in singular IP packets 225. That is, instead of transmitting singular IP packets 225 to the AS 215, the AC 201 may transmit one or more PDU sets 235, where a PDU set 235 includes a set of IP packets 225 (e.g., one or more IP packets 225) and represents a unit of information associated with the XR application at the AC 201 (e.g., a slice or portion of a video frame or camera frame, which can be forward error correction (FEC) protected). As described herein, a PDU set 235 may be referred to as an application data unit (ADU). A burst 230 (e.g., a periodic burst transmission) may include a set of PDU sets 235 (e.g., one or more PDU sets 235), where each of the PDU sets 235 may be associated with a same delivery deadline at the UE 115-a. In such examples, the burst 230 may carry all slices (e.g., portions) of an XR video frame or one or more slices of the XR video frame. In some examples, the XR application operating at the UE 115-a may determine the transport layer parameters for the PDU sets 235. Further, in 5G XR communications, the UE 115-a and the AS 215 may utilize an enhanced RTP to indicate the metadata associated with each PDU set 235.

In some examples, each of the PDU sets 235 may be associated with a QoS parameter, such as a PDU set delay budget (PSDB), where the PSDB may be used in place of a packet delay budget (PDB). The PSDB may define an upper bound for a delay that a PDU set 235 may experience for the transfer between the UE 115-a and the UPF 205 (e.g., the N6 termination point at the UPF 205).

As an illustrative example, the AC 201 may output, via a communication link 220-a, one or more bursts 230 to the UE modem 203, such as a burst 230-a, a burst 230-b, and a burst 230-c. The burst 230-a may include a PDU set 235-a and PDU set 235-b, where both the PDU set 235-a and the PDU set 235-b have a same delivery deadline at the AS 215. The burst 230-b may include a PDU set 235-c, a PDU set 235-d, and a PDU set 235-e, where the PDU set 235-c, the PDU set 235-d, and the PDU set 235-e have a same delivery deadline at the AS 215. Similarly, the burst 230-c may include the PDU set 235-f. As described herein, each PDU set 235 may include one or more IP packets 225.

Accordingly, in response to receiving the bursts 230 from the AC 201, the UE modem 203 may forward the bursts 230 to the RAN 202 via the communication link 220-b, which may be referred to as an UU interface. The RAN 202 may receive the bursts 230 from the UE 115-a (e.g., from the UE modem 203) and proceed to forward the bursts 230 to the UPF 205 via the communication link 220-c, which may be referred to as an N3 interface. In response to receiving the bursts 230, the UPF 205 may forward the bursts 230 to the DN 210 over the communication link 220-d, which may be referred to as an N6 interface. The DN 210 may forward the bursts 230 to the AS 215 over the communication link 220-e. In this way, the AS 215 may obtain a camera frame or other uplink data associated with the XR application from the AC 201.

In some examples, the communication flow between the AC 201 and the AS 215 may be associated with jitter, and the jitter may be based on a statistical calculation of frame generation times and arrival times of one or more bursts 230 over the communication flow. Accordingly, the jitter of the communication flow may be associated with a minimum arrival time of a burst 230 (e.g., the earliest time a burst 230 may be generated by the AC 201), an average arrival time of a burst 230 (e.g., when the average burst 230 is generated by the AC 201), and a maximum arrival time of a burst 230 (e.g., the latest time a burst 230 may be generated by the AC 201).

The source of the jitter window (e.g., cause of the jitter in a burst arrival time of the bursts 230) may be based on jitter associated with generation time of the bursts 230 and the encoding time of the bursts 230 at the AC 201 (e.g., rendering, encoding, and packetizing of a camera frame), jitter of packet delivery over the communication link 220-a, or a combination thereof. In such examples, jitter incurred during generation of the bursts 230 may be relatively larger (e.g., the major source of jitter) than the jitter incurred over the communication link 220-a (e.g., a minor or negligible source of jitter). In some examples, such as in edge computing, the jitter incurred over the communication link 220-a may be negligible based on the bursts 230 being delivered internally within the UE 115-a.

The techniques described herein may increase resource savings, increase power savings, while meeting application-specific latency specifications. The RAN (e.g., network) may save uplink resources by configuring a smaller quantity of configured grant resources. The UE 115 may stay longer in a sleep mode. The power savings may depend on the traffic pattern and timing. The XR application may experience no difference in latency based on the XR traffic arriving before the delivery deadline.

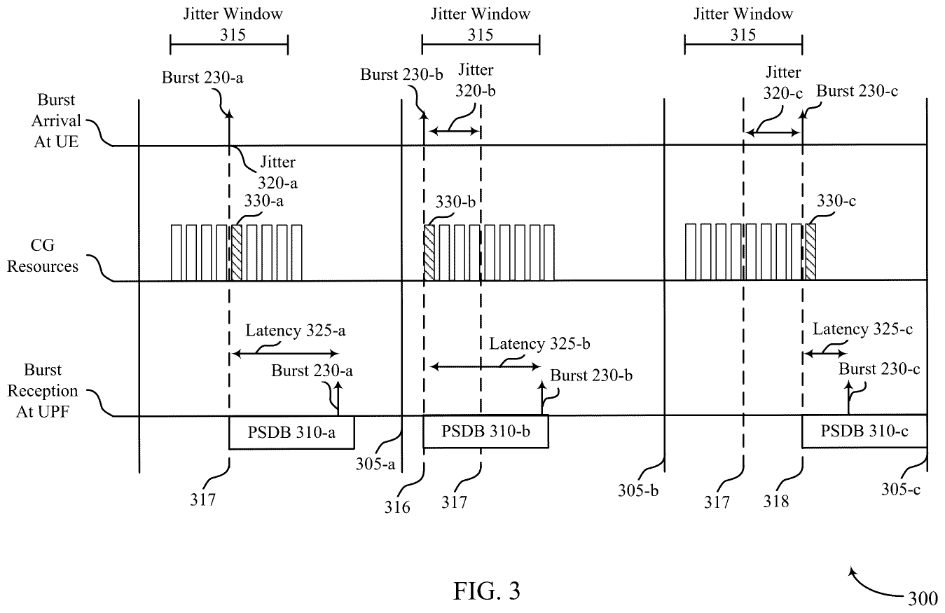

FIG. 3 shows an example of a timing diagram 300 that supports mitigating jitter in uplink communications in accordance with one or more aspects of the present disclosure. Aspects of the timing diagram 300 may implement, or be implemented by, aspects of the wireless communications system 100 and the wireless communications system 200. For example, a UE 115, an AC 201, a RAN 202, a UE modem 203, a UPF 205, a DN 210, or an AS 215, which may be examples of corresponding devices described with reference to FIGS. 1 and 2, may communicate according to the timing diagram 300.

The timing diagram 300 may include a timeline corresponding to the arrival times of the bursts 230 at the UE 115 (e.g., at a AC 201 of the UE 115 or a UE modem 203 of the UE 115), where the burst arrival times at the UE 115 may be shown relative to the configured grants provided by the RAN 202 and relative to the burst arrival times at the UPF 205.

In the example of the timing diagram 300, a UE 115 may obtain bursts 230 based on framer generation at the AC 201. In such examples, each burst 230 may be associated with a respective delivery deadline 305. For example, a burst 230-a may be associated with a delivery deadline 305-a, a burst 230-b may be associated with a delivery deadline 305-b, and a burst 230-c may be associated with a delivery deadline 305-c. The delivery deadline 305 may represent a time at which the AS 215 consumes the data included in the respective bursts 230, otherwise the data included in the bursts 230 becomes invalid. That is, the delivery deadlines 305 may represent the upper-bound time by when a burst 230 may be delivered and still provide the AS 215 with sufficient time to meet a playtime time or display refresh time for downlink traffic at the AC 201. In such examples, the delivery deadlines 305 may be associated with a same application at the UE 115, and be periodic since playout time may be periodic (e.g., the display refresh time of the application may be periodic).

Additionally, as described herein, each burst 230 may be associated with a communication latency 325 and a PSDB 310, for example, the burst 230-a may be associated with a communication latency 325-a and a PSDB 310-a, the burst 230-b may be associated with a communication latency 325-b and a PSDB 310-b, and the burst 230-c may be associated with a communication latency 325-c and a PSDB 310-c. As illustrated, and described herein, each of the PSDBs 310 may start relative to the arrival times of the bursts 230 at the UE 115-a. That is, the PSDBs 310 may start (e.g., begin or start) in response to the arrival of the bursts 230 at the UE 115-a.

The communication flow between the UE 115 and the AS 215 may be associated with jitter 320, which may occur within a jitter window 315. The jitter window 315 may span a time period that includes an average arrival time 317 (e.g., average arrival time of the bursts 230 at the UE 115-a), a minimum arrival time 316 (e.g., a minimum arrival time of the bursts 230 at the UE 115-a) from the average arrival time 317, and an average a maximum arrival time 318 (e.g., a maximum arrival time of the bursts 230 at the UE 115-a) from the average arrival time 317 (one or more of the minimum arrival time 316, the average arrival time 317, or the maximum arrival time 318 may not be shown in FIG. 3 in connection with bursts 230-a, 230-b, and 230-c, depending on context). For example, the jitter windows 315 may be a statistical calculation of the arrival times of one or more bursts 230 over a communication flow between the AC 201 and the AS 215. In such examples, the jitter window 315 associated with each burst 230 may be relative to the generation time of the bursts 230 at the AC 201, such that the minimum arrival time 316, the average arrival time 317, and the maximum arrival time 318 associated with a respective burst 230 may be identified relative to the start time of the generation of the respective burst 230 at the AC 201.

In some examples, the bursts 230 may not be affected by jitter 320, such that the bursts 230 may arrive at the UE 115 at the average arrival time 317 and subsequently arrive at the UE 115 prior to the delivery deadline 305 and within the PSDB 310. For example, the burst 230-a may arrive at the UE 115 at a time corresponding to the average arrival time 317, where the jitter 320-a may be equal to 0. As such, the UE 115 may transmit the burst 230-a to the RAN 202, where the RAN 202 may forward the burst 230-a to the UPF 205. After the UE 115 transmit the burst 230-a, the burst 230-a may be delayed by a communication latency 325-a before being received by the UPF 205. The UPF 205 may receive the burst 230-a within the PSDB 310-a and prior to the delivery deadline 305-a.

In some other examples, however, due to the jitter 320 associated with the bursts 230 and to meet the delivery deadlines 305 and PSDBs 310, the RAN 202 may configure the UE 115 with multiple configured grants 330 to cover the jitter window 315. For example, the RAN 202 may provide multiple configured grants 330 a first time after the minimum arrival time 316 and a second time after the maximum arrival times 318 of the jitter windows 315. As such, the UE 115 may timely transmit a burst 230 via a configured grant throughout the duration of the jitter window 315. The UE may use a single configured grant 330 of the multiple configured grants 330. In some examples, the UE 115 may obtain the burst 230-a (e.g., a nominal burst 230 associated with jitter 320-a) and transmit the burst 230-a via a configured grant 330-a within the jitter window 315. In some examples, the UE 115 may obtain a burst 230-b (e.g., an early burst 230 associated with jitter 320-b) and transmit the burst 230-b via an initial configured grant 330-b within the jitter window 315. In some examples, the UE 115 may obtain a burst 230-c (e.g., a later burst 230 associated with jitter 320-c) and transmit the burst 230-c via a configured grant 330-c within or after the jitter window 315.

Accordingly, due to the aggressive quantity of configured grants, the RAN 202 may unnecessarily expend uplink communication resources by configuring the multiple configured grants 330 within the jitter window 315. The UE 115 may transmit uplink control information (UCI) for the unused configured grant report, increasing power consumption at the UE 115 and decreasing communication efficiency, based on the UE 115 sending the UCI for unused configured grants. Additionally, the UE 115 may not know when the uplink traffic is going to arrive due to jitter 320, so the UE 115 may wake up and remain awake during the entire jitter window 315. For example, the UE 115 may perform a wake up procedure over a duration (e.g., several ms), so the UE 115 may be unable to perform the wake up procedure once the uplink traffic arrivals (e.g., the UE 115 may perform the wake up procedure before the uplink traffic arrives based on the duration). In some implementations (e.g., if dynamic uplink skipping of configured grants is not allowed), the UE 115 may send dummy uplink data via all the unused configured grant resources, further increasing power consumption at the UE 115.

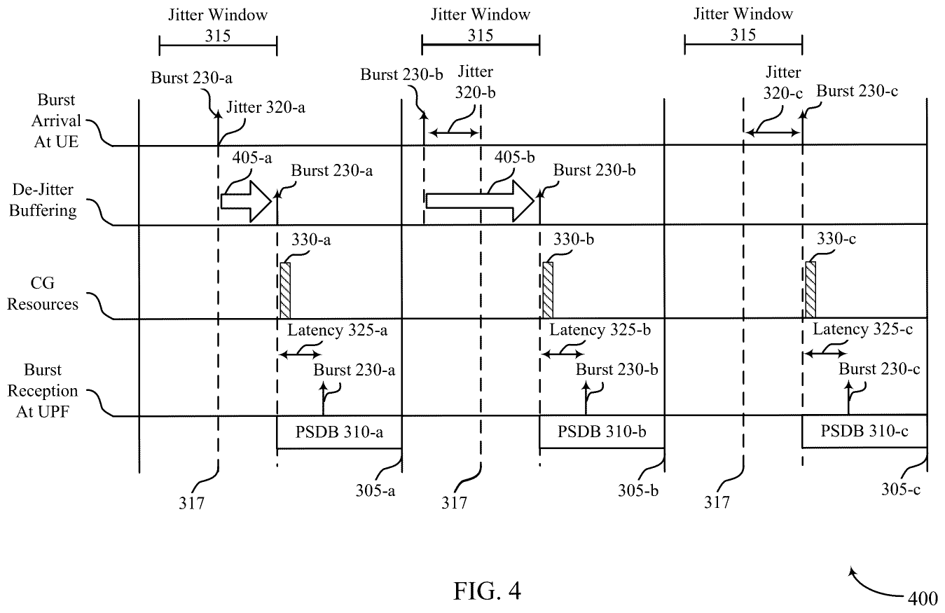

To reduce the quantity of configured grants provided by the RAN 202, the techniques described herein may enable the AC 201 or the UE 115 to delay the bursts 230 for a threshold percentage of the jitter window 315. Such techniques may be further described herein with reference to FIGS. 4-8.

FIG. 4 shows an example of a timing diagram 400 that supports mitigating jitter in uplink communications in accordance with one or more aspects of the present disclosure. Aspects of the timing diagram 400 may implement, or be implemented by, aspects of the wireless communications system 100, the wireless communications system 200, and the timing diagram 300. For example, a UE 115, a RAN 202, a UPF 205, a DN 210, or an AS 215, which may be examples of corresponding devices described with reference to FIGS. 1 and 2, may communicate according to the timing diagram 400. The timing diagram 400 may include delivery deadlines 305 (e.g., a delivery deadline 305-a, a delivery deadline 305-b, and a delivery deadline 305-c) and PSDBs 310 (e.g., a PSDB 310-a, a PSDB 310-b, and PSDB 310-c), which may be examples of the delivery deadlines 305 and PSDBs 310, as described herein with reference to FIG. 3. The timing diagram 400 may also include a jitter window 315, a minimum arrival time 316, an average arrival time 317, and a maximum arrival time 318, which may be examples of corresponding times as described herein with reference to FIG. 3.

The timing diagram 400 may include a timeline corresponding to the arrival times of the bursts 230 at the UE 115-a, where the burst arrival times at the UE 115-a may be shown relative to the configured grants provided by the RAN 202 and relative to the burst arrival times at the UPF 205.

In accordance with the techniques described herein, because there is no impact to the XR application at the UE 115 if the burst 230 arrives at the AS 215 by the delivery deadlines 305 and because the PSDB 310 starts when the bursts 230 arrive at the UE 115, the bursts 230 may be buffered by a delay 405, such that the arrival times of the bursts 230 at the UPF 205 are deterministic and prior to the delivery deadlines 305. For example, the AC 201 or the UE 115 may delay the early arriving bursts, while still providing the same PSDB 310. This may enable the RAN 202 to configure a less aggressive quantity of configured grants 330, reducing power consumption at the UE 115 and increase efficient use of communication resources.

In some examples, the AC 201 may buffer or delay delivering a burst 230 (e.g., a frame or PDU Set) to the UE modem 203 until a percentile of the maximum jitter (e.g., to reduce the jitter range). In some examples, the UE modem 203 may buffer or delay delivering the burst 230 (e.g., the frame or the PDU set) to the RAN 202 until a percentile of the maximum jitter (e.g., to reduce the jitter range) The PSDB may start from the delayed burst 230 (e.g., the PSDB may start after the burst 230 is buffered at the UE modem 203).

As an illustrative example, the AC 201 or the UE 115 may buffer the burst 230-a by a delay 405-a (e.g., a duration), where the delay 405-a may correspond to a first threshold percentage of the jitter window 315 (e.g., 90% of the jitter window). Accordingly, a remaining jitter may be equal to the difference between the jitter window 315 and the delay 405-a (e.g., 10% of the jitter window). As such, the RAN 202 may configure a reduced quantity (e.g., a single) configured grant 330-a accordingly, such that the UE 115 may experience power savings.

As another illustrative example, the AC 201 or the UE 115 may buffer the burst 230-b by a delay 405-b (e.g., a duration), where the delay 405-b corresponds to a second threshold percentage of the jitter window 315 (e.g., 99% of the jitter window). Accordingly, a remaining jitter may be equal to the difference between the jitter window 315 and the delay 405-b (e.g., 1% of the jitter window). As such, the RAN 202 may configure a reduced quantity (e.g., a single) configured grant 330-b accordingly, such that the UE 115 may experience power savings.

As another illustrative example, the AC 201 or the UE 115 may buffer the burst 230-c for a duration that corresponds to a third threshold percentage of the jitter window 315 (e.g., greater than 99% of the jitter window or 100% of the jitter window). Accordingly, a remaining jitter may be equal to less than 1% of the jitter window. In some examples, the AC 201 or the UE 115 may obtain the burst 230-c after the third threshold percentage of the jitter window 315, and the AC 201 or the UE 115 may not buffer the burst 230-c. That is, there may be no remaining jitter or negligible remaining jitter. As such, the RAN 202 may configure a reduced quantity (e.g., a single) configured grant 330-c accordingly, such that the UE 115 may experience power savings.

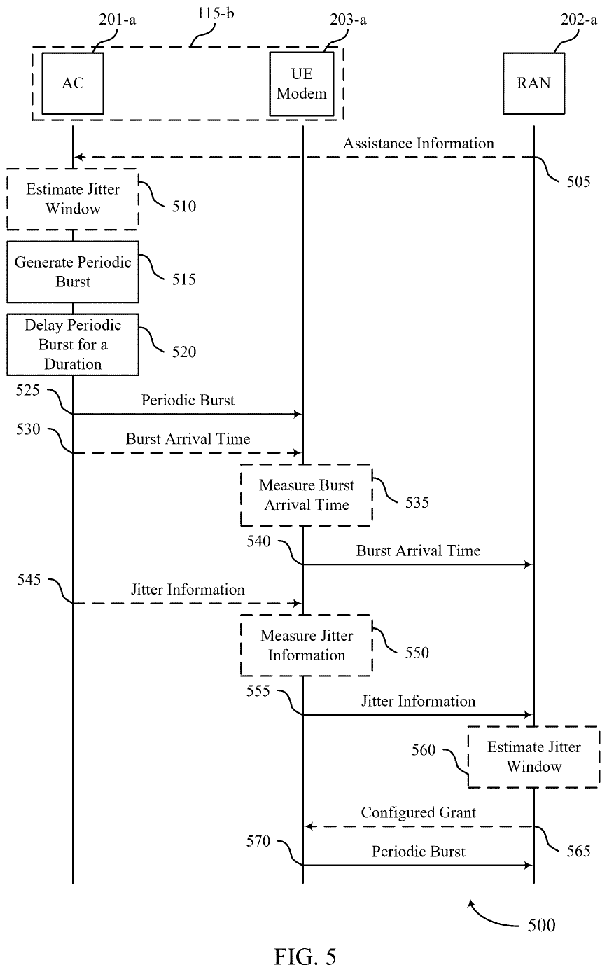

In such examples, the bursts 230 may be delayed by the AC 201 or the UE 115 in accordance with the techniques described herein with reference to FIGS. 5-8. Additionally, although three illustrative examples of the delay 405 are described, it should be understood that the bursts 230 or one or more PDU sets of a burst may be delayed by any threshold percentage of the jitter window that results in a deterministic arrival time of the bursts 230, thereby enabling the RAN 202 to configure a reduced quantity (e.g., a single) configured grant 330. For example, the RAN may configure (e.g., set a smaller quantity of configured grants without considering the wide jitter window 315.

In this way, by buffering the bursts 230 for the delays 405 (e.g., durations corresponding to a threshold percentage of the jitter window 315), the UPF 205 may receive the bursts 230 prior to the delivery deadlines 305 and within the PSDBs 310, while also experiencing power savings and increasing efficient usage of communication resources. For example, because the quantity of configured grants 330 may be reduced (relative to the configured grants 330 of FIG. 3), the UE 115 may reduce awake time and reduce uplink transmission (e.g., dummy uplink transmissions on unused configured grants 330), thereby saving power at the UE 115.

In some examples, the UE 115 may report the reduced jitter and a burst arrival time in UAI for uplink traffic. In some examples, the UE 115 may report the reduced jitter in a DSR. The reduced jitter may include the remaining jitter between the burst 230 after delaying the bursts 230 for the threshold percentage of the jitter window.

FIG. 5 shows an example of a process flow 500 that supports mitigating jitter in uplink communications in accordance with one or more aspects of the present disclosure. Aspects of the process flow 500 may implement, or be implemented by, aspects of the wireless communications system 100, the wireless communications system 200, the timing diagram 300, and the timing diagram 400 as described herein with reference to FIGS. 1-4. For example, the process flow 500 may include a UE 115-b and a RAN 202-a which may be examples of corresponding devices described with reference to FIGS. 1-4. In some implementations, the UE 115-b may include an AC 201-a and a UE modem 203-a, which may be examples of corresponding devices described with reference to FIGS. 1-4. In some implementations, the AC 201-a and the UE modem 203-a may be included in separate wireless devices. In the following description of the process flow 500, the operations may be performed in a different order than the order shown. Specific operations also may be left out of the process flow 500, or other operations may be added to the process flow 500. Further, although some operations or signaling may be shown to occur at different times for discussion purposes, these operations may actually occur at the same time. The techniques described in the context of the process flow 500 may enable the AC 201-a to delay a first periodic burst transmission, thereby mitigating the effects of jitter in the wireless communications system.

The AC 201-a may obtain an indication of whether a flow will be periodically consumed by the AS 215 regardless of jitter. For example, at 505, the AC 201-a may obtain an indication that a set of periodic burst transmissions associated with a data flow are consumed by the AS 215 at a set of periodic delivery deadlines. The set of periodic burst transmissions may include a first periodic burst transmission, and the set of periodic delivery deadlines may include a first delivery deadline. In some implementations, the AS 215 may provide assistant information. The assistance information may indicate a flow for de-jitter buffering, a deadline, a delivery deadline, a periodicity, or a jitter associated with an XR application at the AC 201-a.

At 510, the AC 201-a may estimate the jitter window associated with the first periodic burst transmission based on a reference table and communication conditions. For example, the AC 201-a may obtain the jitter statistics of the communication flow based on a jitter estimation algorithm.

In some examples, the AC 201-a may utilize a static jitter estimation algorithm to estimate the jitter window. The AC 201-a may estimate the jitter statistic (e.g., jitter window) from the previous statistical information For example, the AS 215 may store one or more previously measured jitter windows associated with previous periodic burst transmissions in a reference table. The previously measured jitter windows may be categorized, or stored, according to one or more operating conditions that were present during the transmission of the previous periodic burst transmissions.

Such operating conditions may include a workload of the AS 215, a workload of the UE 115-b, a workload of the AC 201-a, a workload of the UE modem 203-a, an XR traffic pattern, a data rate of the previous periodic burst transmissions, or a periodicity associated with the previous periodic burst transmissions. As such, the AC 201-a may utilize the stored jitter windows, measured from previous periodic burst transmissions, to estimate the jitter window associated with the first periodic burst transmission.

For example, the AC 201-a may measure a set of jitter windows and a corresponding set of communication conditions associated with communication of a set of periodic burst transmissions. The set of periodic burst transmissions may be prior to the first periodic burst transmission, and the reference table may be based on the set of jitter windows and the corresponding set of communication conditions. The communication conditions may include an operating condition of the AS 215, a data rate of the first periodic burst transmission, a periodicity associated with the first periodic burst transmission, or any combination thereof.

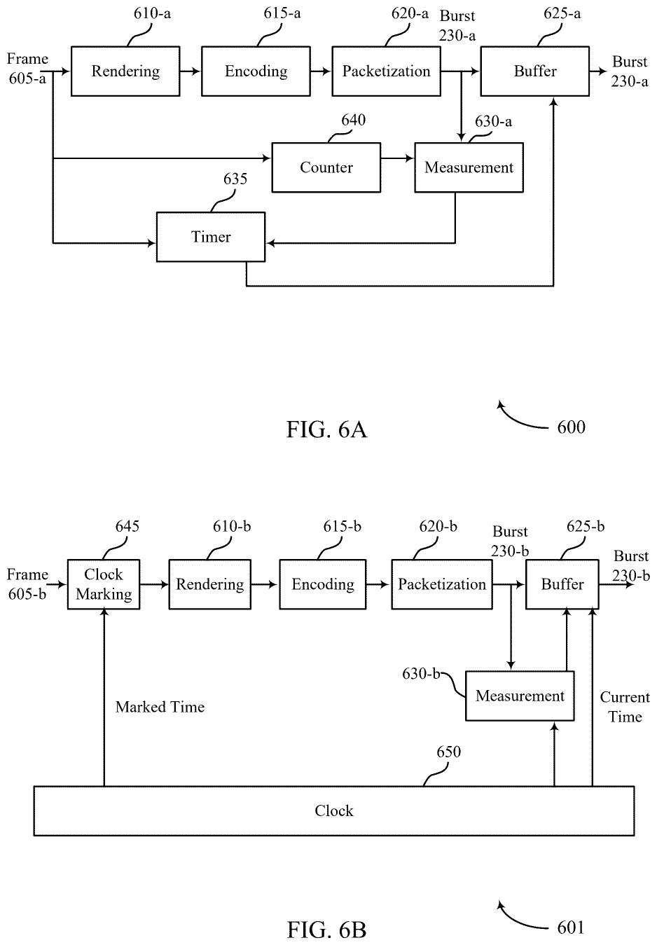

In some examples, the AC 201-a may utilize a dynamic jitter estimation algorithm to estimate the jitter window, where the AC 201-a may estimate the jitter window dynamically (e.g., estimate the jitter window during ongoing frame generation). For example, for periodic burst generation (e.g., frame generation), the AC 201-a may obtain an indication as to when a periodic burst transmission is generated (e.g., the AC 201-a may obtain a start time of generation). As such, based on the start time of the generation, the AC 201-a may measure a duration associated with generating the first periodic burst transmission. Accordingly, after the periodic burst transmission (e.g., frame) is generated, the AC 201-a may estimate the jitter window associated with subsequent periodic burst transmissions based on the measured duration (e.g., frame generation time). Techniques to dynamically estimate the jitter window may be further described herein with reference to FIGS. 6A and 6B. If the jitter statistic (e.g., jitter window) is consistently updated, the AC 201-a may output an indication of the jitter window (e.g., related information) to the RAN 202 (e.g., UAI for uplink traffic information).

In some examples, the AC 201-a may measure a duration associated with generating the one or more PDU sets of the first periodic burst transmission, and the AC 201-a may estimate the jitter window based on the duration associated with generating the one or more PDU sets.

In some examples, the AS 215 may utilize a hybrid jitter estimation algorithm to estimate the jitter window. For example, the AS 215 may estimate the jitter window associated with the first periodic burst transmission using both previous jitter window measurements (e.g., previous statistical information) and using dynamic jitter window measurements during ongoing frame generation. For example, the AC 201-a may begin the jitter window estimation by using the previously stored jitter windows (e.g., jitter statistics). Accordingly, while the AS 215 generates the one or more PDU sets of an initial periodic burst transmission (e.g., XR frames), the AS 215 may update the jitter window estimation. That is, after obtaining the duration associated with generating the initial periodic burst transmission, the AC 201-a may utilize the measured duration and previously measured jitter durations to estimate the jitter window associated with the first periodic transmission. If the jitter statistic (e.g., jitter window) is consistently updated, the AC 201-a may output an indication of the jitter window (e.g., related information) to the RAN 202 (e.g., UAI for uplink traffic information).

In some examples, the AC 201-a may measure one or more jitter windows associated with communication of one or more periodic burst transmissions. The one or more periodic burst transmissions may be prior to the first periodic burst transmission. The AC 201-a may measure a duration associated with generating the one or more PDU sets of the first periodic burst transmission, and the AC 201-a may estimate the jitter window based on the duration associated with generating the one or more PDU sets, a reference table, and communication conditions. Additionally, or alternatively, the AC 201-a may measure one or more jitter windows associated with communication of one or more additional periodic burst transmissions and one or more communication conditions associated with the communication of the one or more additional periodic burst transmissions, the one or more additional periodic burst transmissions being after the set of periodic burst transmissions, and the AC 201-a may update the reference table based on measuring the one or more jitter windows and the one or more communication conditions. Estimating the jitter window may be based on updating the reference table.

In some examples, the AC 201-a may ignore abnormal jitters. For example, if the AC 201-a generates a periodic burst transmission associated with a jitter that is greater than a threshold jitter, then the AC 201-a may ignore the abnormal jitter, and refrain from storing the abnormal jitter in the reference table or as a part of jitter window estimation.

At 515, the AC 201-a may generate one or more PDU sets of a first periodic burst transmission during a jitter window. The first periodic burst transmission may correspond to a first delivery deadline at the AS 215 and the jitter window may span a time period prior to or after a first arrival time associated with the one or more PDU sets. For example, the AC 201-a may generate the frame (e.g., PDU Set, Burst) with jitter. The jitter may be based on a rendering time, an encoding time, and a packetization time, as described with reference to FIG. 2.

At 520, the AC 201-a may delay the one or more PDU sets for a first duration of the jitter window. The first duration may correspond to a threshold percentage of the jitter window. For example, the AC 201-a may, via buffering, delay delivering the burst (e.g., generated frame or PDU Set) to the UE modem 203-a until a threshold of the jitter window (e.g., a threshold of the maximum jitter).

The AC 201-a may delay the first periodic burst transmission for a duration that corresponds to a percentage of the jitter window. In some examples, the AC 201-a may delay the first periodic burst transmission for a duration that corresponds to 90% of the jitter window, as described herein with reference to FIG. 4. In some examples, the AC 201-a may delay the first periodic burst transmission for a duration that corresponds to 99% of the jitter window, as described herein with reference to FIG. 4. In some examples, the AS 215 may delay the first periodic burst transmission for a duration that corresponds to 100% of the jitter window, as described herein with reference to FIG. 4.

A PSDB associated with the first periodic burst transmission may be counted when the delayed PDU Set arrives at UPF 205. The first periodic burst transmission may still meet the delivery deadline after the delay, as described with reference to FIG. 4.

At 525, the AC 201-a may output the one or more PDU sets to the UE modem 203-a based on expiration of the first duration and prior to the first delivery deadline. For example, the AC 201-a may transmit, and the UE modem 203-a may receive, a periodic burst transmission.

In some implementations (e.g., in a local timer-based implementation), the AC 201-a may start a timer in response to obtaining the one or more PDU sets. The timer may be set to the first duration (e.g., the threshold percentage of the jitter window). Buffering the one or more PDU sets may be based on starting the timer, and outputting the first periodic burst transmission may be based on expiration of the timer, as described with reference to FIG. 6A. For example, the timer may be set to an initial value, and the value of the timer may decrease over time. The one or more PDU sets may be buffered until the expiration of the timer (e.g., when the value of timer is zero). In some implementations (e.g., in a global timer-based implementation), the AC 201-a may identify a start time associated with the one or more PDU sets in response to obtaining the one or more PDU sets, and the AC 201-a may delay the one or more PDU sets from the start time for the first duration. Outputting the one or more PDU sets may be based on the expiration of the first duration, as described with reference to FIG. 6B. For example, the AC 201-a may store a start time when generating the one or more PDU sets initializes. The AC 201-a may buffer the one or more PDU sets until a current time is equivalent to a sum of the start time and a frame generation time associated with the threshold percentage of the jitter window.

In some implementations, at 530, the UE modem 203-a may obtain burst arrival time information from the AC 201-a (e.g., via an XR application program interface (X-API) of the AC 201-a). In some implementations, at 535, the UE modem 203-a may measure the burst arrival time of the first periodic burst transmission.

At 540, the UE 115-b may output, via the UE modem 203-a, an indication of a burst arrival time associated with the first periodic burst transmission. For example, the UE 115-b may report a burst arrival time of the first periodic burst transmission to the RAN 202-a (e.g., via UAI message for uplink traffic information). The burst arrival time may be a shifted burst arrival time after the de-jitter buffering at 520.

In some implementations, at 545, e.g., the UE modem 203-a may obtain jitter information from the AC 201-a (e.g., via the X-API). For example, the UE modem 203-a and the AC 201-a may communicate via an internal connection of the UE 115-b, as described herein. In some implementations, at 550, the UE 115-b may measure the jitter information of the first periodic burst transmission. The measured jitter information may be based on the jitter between the UE modem 203-a and the AC 201-a, although the jitter between the UE modem 203-a and the AC 201-a may be quite stable. For example, additional jitter between the UE modem 203-a and the AC 201-a may alter the burst arrival time at the UE modem 203-a. The measured jitter information may include a remaining jitter associated with the generation of the periodic burst transmission and the jitter between the UE modem 203-a and the AC 201-a.

At 555, the UE 115-b may output, via the UE modem 203-a, jitter information including an indication of the jitter window associated with the first periodic burst transmission. For example, the UE 115-b may report a remaining jitter of the first periodic burst transmission to the RAN 202-a (e.g., via UAI message for uplink traffic information). The remaining jitter may include the jitter associated with periodic burst transmissions after the delay. For example, the remaining jitter may include a reduced jitter window spanning the remaining percentage of the jitter window (e.g., a portion of the jitter window after the threshold percentage of the jitter window).

At 560, the RAN 202-a may process the jitter information (e.g., via an artificial intelligence (AI) model, a machine learning (ML) model, or a statistic algorithm) to extract the XR traffic pattern or other information from the jitter information. For example, the RAN 202-a may estimate the jitter window, the jitter information, or the burst arrival time based on receiving one or more previous periodic burst transmissions.

At 565, the RAN 202-a may configure one or more configured grants based on the XR traffic pattern of UAI message (e.g., based on the remaining jitter and the burst arrival time indicated via a UAI message). For example, the RAN 202-a may allocate configured grants to the UE 115-b based on a burst arrival time, a remaining jitter, or a jitter window associated with the XR traffic. A quantity of consecutive configured grant resources may be set based on the burst arrival time or the jitter information (e.g., remaining jitter) indicated via the UAI for uplink traffic information or estimated by the RAN 202-a. The RAN 202-a may set configured grant offsets based on the burst arrival time or jitter information indicated via the UAI for uplink traffic information or estimated by the RAN 202-a. For example, the offset of each configured grant resource may be set based on the shifted burst arrival time and remaining jitter. The RAN 202-a may reduce the quantity of configured grants based on the burst arrival time and jitter information. For example, the RAN 202-a may configure a reduced quantity of configured grants based on the AC 201-a delaying the periodic burst transmissions, as described with reference to FIG. 4. The RAN 202-a may transmit an indication of the configured grants to the UE 115-b, and the UE 115-b may perform a wake up procedure prior to the configured grants (e.g., the UE 115-b may wake late for the reduced quantity of configured grants).

At 570, the UE modem 203-a may transmit the PDU set prior to expiration of the PSDB. The PDU sets may be delivered to the AS 215 prior to the delivery deadline, as described with reference to FIG. 4.

The techniques described herein for buffering at the AC 201-a may reduce the jitter associated with frame generation and encoding time. The UE 115 may perform the de-jitter procedure described in accordance with FIG. 5 the without upgrades.

FIGS. 6A and 6B shows an example of a buffering diagram 600 and an example of a buffering diagram 601 that supports mitigating jitter in uplink communications in accordance with one or more aspects of the present disclosure. One or more aspects of the buffering diagram 600 and buffering diagram 601 may be implemented by a network device, such as an AS 215, a UPF 205, or a RAN 202 as described with reference to FIGS. 1-5. The buffering diagram 600 may include rendering component 610-a, an encoding component 615-a, a packetization component 620-a, a buffer component 625-a, a measurement component 630-a, a timer 635, and a counter 640. The buffering diagram 601 may include a rendering component 610-b, an encoding component 615-b, a packetization component 620-b, a buffer component 625-b, a measurement component 630-b, a clock marking component 645, and a clock 650. The techniques described in the context of the buffering diagram 600 and the buffering diagram 601 may enable the UE 115 (e.g., the AC 201 or the UE modem 203) to delay a burst 230 (e.g., a first periodic burst transmission).

With reference to the buffering diagram 600 of FIG. 6A, the UE 115 may implement a local timer-based implementation for buffering the burst 230-a. For example, when an event (e.g., generation of the burst 230-a from the frame 605-a) starts, the UE 115 (e.g., AS 215) may start the timer 635, which has been set to an initial value (e.g., a duration corresponding to the threshold percentage of a jitter window). Additionally, the UE 115 may initiate the counter 640, which may start from zero. To generate the burst 230-a, the UE 115 (e.g., the AC 201) may begin to capture camera data and render a camera frame 605-a using the rendering component 610-a, encode the camera frame 605-a using the encoding component 615-a, and packetize the encoded camera frame 605-a using the packetization component 620-a to obtain the burst 230-a.

As such, during the rendering, encoding, and packetization, the timer 635 (e.g., duration corresponding to a threshold percentage of the jitter window) may decrease while the counter 640 may increase. In response to the completion of the burst 230-a, the buffer component 625-a may delay (e.g., hold) the burst 230-a (e.g., the generated frame) until the timer 635 expires (e.g., until expiration of the duration). When the timer 635 expires, the buffer component 625-a of the network device may release the portion of the burst 230-a, such that the UE 115 may output the burst 230-a (e.g., output the burst 230-a to the UE modem 203 if the frame is buffered at the AC 201 or output the burst 230-a to the RAN 202 if the frame is buffered at the UE modem 203). In this way, the UE 115 may buffer the burst 230-a for a threshold percentage of the jitter window.

In such examples, the network device may utilize the value of the counter 640 to update the statistics regarding the jitter window using the measurement component 630-a. For example, because the generation of the burst 230-a (e.g., rendering, encoding, and packetizing) causes the majority of the jitter for the burst 230-a, the UE 115 may update the statistics regarding the jitter window according to the generation time of the burst 230-a (e.g., the value of the counter 640). The UE 115 may update the minimum arrival time (e.g., minimum arrival time 316) of the jitter window, the average arrival time of the jitter window (e.g., the average arrival time 317), the maximum arrival time (e.g., the maximum arrival time 318) of the jitter window, the mean of the jitter window, a variance of the jitter window, a percentile of the jitter window, or a combination thereof, based on the value of the counter 640 (e.g., the duration associated with generating the burst 230-a). Accordingly, the measurement component 630-a may update the initial value of the timer 635 (e.g., the duration corresponding to the threshold percentage of the jitter window) according to the updated jitter statistics.

Such techniques may be utilized by the UE modem 203, where the rendering component 610-a, the encoding component 615-a, and the packetization component 620-a may be skipped or replaced by obtaining the one or more PDU sets of the burst 230-a. For example, in response to obtaining the burst 230-a, the UE modem 203 may initiate the timer 635 that is set to an initial value, and buffer the burst 230-a until expiration of the timer 635 using the buffer component 625-a.

With reference to the buffering diagram 601, the UE 115 (e.g., the AC 201 or the UE modem 203) may implement a global timer-based implementation for buffering the burst 230-b. For example, when an event starts (e.g., generation of the burst 230-b from a camera frame 605-b), the UE 115 may mark (e.g., identify) a time associated with the start of the rendering of the camera frame 605-b, where such a time may be referred to as a marked time. To generate the burst 230-b, the UE 115 may begin to capture camera data and render the camera frame 605-b using the rendering component 610-b, encode the camera frame 605-b using the encoding component 615-b, and packetize the encoded camera frame 605-b using the packetization component 620-b to obtain the burst 230-b.

In response to the completion of at least a portion of the burst 230-b, the buffer component 625-a may delay (e.g., hold) the generated the burst 230-b (e.g., generated frame) until a duration (e.g., the duration corresponding to a threshold percentage of the jitter window) has expired. For example, in response to completion of the generated burst 230-b, the clock 650 may indicate to the buffer component 625-b a current time (e.g., a time at which the burst 230-b was fully generated). Accordingly, the buffer component 625-b may calculate a frame generation time (e.g., frame generation duration) associated with the burst 230-b based on the marked time and the current time (e.g., frame generation time=current time−marked time). Accordingly, if the duration associated with the frame generation time (e.g., marked time+frame generation time) is below the duration corresponding to the threshold percentage of the jitter window, the buffer component 625-b may delay the burst 230-b. Alternatively, if the duration associated with the frame generation time (e.g., marked time+frame generation time) is greater than, or equal to, the duration corresponding to the threshold percentage of the jitter window, the buffer component 625-b may release the burst 230-b, such that the UE 115 may output the burst 230-b (e.g., output the burst 230-a to the UE modem 203 if the frame is buffered at the AC 201 or output the burst 230-a to the RAN 202 if the frame is buffered at the UE modem 203).

In such examples, the UE 115 may utilize the frame generation time to update the statistics regarding the jitter window using the measurement component 630-b. For example, because the generation of the burst 230-b (e.g., rendering, encoding, and packetizing) causes the majority of the jitter for the burst 230-b, the UE 115 may update the statistics regarding the jitter window according to the frame generation time of the burst 230-b. The UE 115 may update the minimum arrival time (e.g., minimum arrival time 316) of the jitter window, the average arrival time of the jitter window (e.g., the average arrival time 317), the maximum arrival time (e.g., the maximum arrival time 318) of the jitter window, the mean of the jitter window, a variance of the jitter window, or a combination thereof based on the frame generation time of the burst 230-b. Accordingly, the measurement component 630-b may update the duration corresponding to the threshold percentage of the jitter window according to the updated jitter statistics.

Such techniques may be utilized by the UE modem 203, where the rendering component 610-b, the encoding component 615-b, and the packetization component 620-b may be skipped or replaced by obtaining of the one or more PDU sets of the burst 230-b. For example, in response to reception of the burst 230-b, the UE modem 203 or may identify the marked time using the clock marking component 645, and buffer the burst 230-b until expiration the duration corresponding to the threshold percentage of the jitter window using the buffer component 625-b.

Although, the buffering diagram 600 and the buffering diagram 601 may be used delay the bursts 230, it should be understood that any methodology by which the AC 201 or UE modem 203 use to buffer the bursts 230 or restrict the jitter window may be applicable to the techniques described herein.

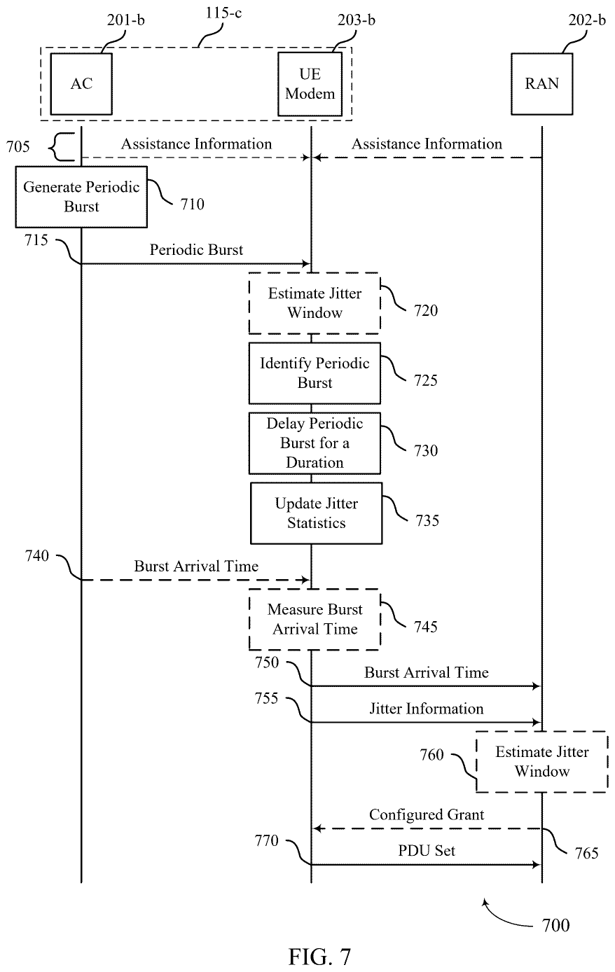

FIG. 7 shows an example of a process flow 700 that supports mitigating jitter in uplink communications in accordance with one or more aspects of the present disclosure. Aspects of the process flow 700 may implement, or be implemented by, aspects of the wireless communications system 100, the wireless communications system 200, the timing diagram 300, the timing diagram 400, the process flow 500, the buffering diagram 600, and the buffering diagram 601 as described herein with reference to FIGS. 1-6B. For example, the process flow 700 may include a UE 115-c, a RAN 202-b, a UPF 205, and an AS 215 which may be examples of corresponding devices described with reference to FIGS. 1-6B. T In some implementations, the UE 115-c may include an AC 201-b and a UE modem 203-b, which may be examples of corresponding devices described with reference to FIGS. 1-6B. In some implementations, the AC 201-b and the UE modem 203-b may be included in separate wireless devices. In the following description of the process flow 700, the operations may be performed in a different order than the order shown. Specific operations also may be left out of the process flow 700, or other operations may be added to the process flow 700. Further, although some operations or signaling may be shown to occur at different times for discussion purposes, these operations may actually occur at the same time. The techniques described in the context of the process flow 700 may enable the UE modem 203-b to delay a first periodic burst transmission, thereby mitigating the effects of jitter in the wireless communications system.

The UE modem 203-b may obtain an indication of whether a flow will be periodically consumed by the AS 215 regardless of jitter. For example, at 705, the UE modem 203-b may obtain an indication that a set of periodic burst transmissions associated with a data flow are consumed by the AS 215 at a set of periodic delivery deadlines. The set of periodic burst transmissions may include the first periodic burst transmission, and the set of periodic delivery deadlines may include the first delivery deadline. In some examples, the UE modem 203-b may receive an indication (e.g., a 5-tuple based indication) associated with the XR traffic. The 5-tupble based indication may indicate an IP addresses, ports, or a transmission control protocol (TCP) or a user datagram protocol (UDP)). In some examples, the AS 215 may provide assistant information via an application function (AF) interface or a network exposed function (NEF) interface. The RAN 202-a may forward the assistance information to the UE modem 203-b. In some examples, the AC 201-b may provide the assistant information to UE modem 203-b via X-API (e.g., a communication connection inside the UE 115-b). The assistance information may indicate whether a flow is compatible with de-jitter buffering, a deadline, a delivery deadline, a periodicity, or jitter.

At 710, the AC 201-b may generate the first periodic burst (e.g., PDU Set or frame) with jitter. The jitter may be based on a rendering time, an encoding time, or a packetization time.

At 715, the UE modem 203-b may obtain one or more PDU sets of a first periodic burst transmission during a jitter window. The first periodic burst transmission may correspond to a first delivery deadline at the AS 215, and the jitter window may span a time period prior to or after a first arrival time associated with the one or more PDU sets. Additional jitter (e.g., jitter based on the communication connection inside the UE 115-b) may be added to the jitter based on generating the first periodic burst transmission. For example, additional jitter between the UE modem 203-a and the AC 201-a may alter the burst arrival time at the UE modem 203-a. The measured jitter information may include a remaining jitter associated with the generation of the periodic burst transmission and the jitter between the UE modem 203-a and the AC 201-a.

At 720, the UE modem 203-b may estimate the jitter window associated with the first periodic burst transmission based on a reference table and communication conditions. In such examples, the UE modem 203-b may estimate the jitter window in accordance with the techniques described herein with reference to the operations at 510 of FIG. 5. For example, the UE modem 203-b may utilize a static jitter estimation algorithm, a dynamic jitter estimation algorithm, or a hybrid jitter estimation algorithm to estimate the jitter window. In such examples, the UE modem 203-b may store the estimated jitter windows at a reference table of the UE modem 203-b according to one or more operation conditions, as described herein with reference to FIG. 5. In some examples, the UE modem 203-b may ignore abnormal jitters. For example, if the UE modem 203-b may obtain a periodic burst transmission associated with a jitter that is greater than a threshold jitter, and the AC 201-a may ignore the abnormal jitter and refrain from storing the abnormal jitter in the reference table or as a part of jitter window estimation.

In some examples (e.g., in a static jitter estimation algorithm), the UE modem 203-b may measure a set of jitter windows and a corresponding set of communication conditions associated with communication of a set of periodic burst transmissions. The set of periodic burst transmissions may be prior to the first periodic burst transmission, and the reference table may be based on the set of jitter windows and the corresponding set of communication conditions.

In some examples (e.g., in a dynamic jitter estimation algorithm), the UE modem 203-b may measure a duration associated with generating the one or more PDU sets of the first periodic burst transmission. The UE modem 203-b may estimate the jitter window based on the duration associated with generating the one or more PDU sets.

In some examples (e.g., in a hybrid jitter estimation algorithm), the UE modem 203-b may measure one or more jitter windows associated with communication of one or more periodic burst transmissions. The one or more periodic burst transmissions may be prior to the first periodic burst transmission. The UE modem 203-b may measure a duration associated with generating the one or more PDU sets of the first periodic burst transmission, and the UE modem 203-b may estimate the jitter window based on the duration associated with generating the one or more PDU sets, a reference table, and communication conditions.

At 725, the UE modem 203-b may identify the first periodic burst transmission (e.g., PDU Set or) from the PDU Set metadata (e.g., RTP or secure RTP header). In some examples, the UE modem 203-b may identify the first periodic burst transmission (e.g., the set of PDUs) belong to an arrival time at a buffer. In some examples, the UE modem 203-b may identify the set of PDUs with an appropriate signal between the AC 201-b (e.g., application processor) and the UE modem 203-b.

At 730, the UE modem 203-b may delay the one or more PDU sets for a first duration of the jitter window. The first duration may correspond to a threshold percentage of the jitter window. In other words, the UE modem 203-b may delay, via buffering, the first periodic burst transmission for a duration that corresponds to a percentage of the jitter window. In some examples, the UE modem 203-b may delay all the PDU of the periodic burst transmission (e.g., PDU set). In some examples, the AC 201-a may delay the first periodic burst transmission for a duration that corresponds to 90% of the jitter window, as described herein with reference to FIG. 4. In some examples, the UE modem 203-b may delay the first periodic burst transmission for a duration that corresponds to 99% of the jitter window, as described herein with reference to FIG. 4. In some examples, the AS 215 may delay the first periodic burst transmission for a duration that corresponds to 100% of the jitter window, as described herein with reference to FIG. 4.

In some implementations (e.g., in a local timer-based implementation), the UE modem 203-b may start a timer in response to obtaining the one or more PDU sets, the timer being set to the first duration. Buffering the one or more PDU sets may be based on starting the timer, and outputting the first periodic burst transmission may be based on expiration of the timer, as described with reference to FIG. 6A. For example, the timer may be set to an initial value, and the value of the timer may decrease over time. The one or more PDU sets may be buffered until the expiration of the timer (e.g., when the value of timer is zero). In some implementations (e.g., in a global timer-based implementation), the UE modem 203-b may identify a start time associated with the one or more PDU sets in response to obtaining the one or more PDU sets, and the UE modem 203-b may delay the one or more PDU sets from the start time for the first duration. Outputting the one or more PDU sets may be based on the expiration of the first duration, as described with reference to FIG. 6B. For example, the AC 201-a may store a start time when generating the one or more PDU sets initializes. The AC 201-a may buffer the one or more PDU sets until a current time is equivalent to a sum of the start time and a frame generation time associated with the threshold percentage of the jitter window.

At 735, the UE modem 203-b may update the jitter statistic (e.g., the jitter window). The jitter statistic may be updated based on the earliest arriving PDU of PDU Set (e.g., the first periodic burst transmission) or the latest arriving PDU of PDU Set (e.g., the first periodic burst transmission). The nominal arrival time may be the average of the burst arrival times within the periodicity. The jitter may be measured based on a nominal arrival time of PDU Set (e.g., the first periodic burst transmission).

In some implementations, at 740, the UE modem 203-b may receive an indication of a burst arrival time associated with the first periodic burst transmission from the AC 201-b (e.g., via an X-API of the AC 201-b). In some implementations, at 745, the UE modem 203-b may measure a burst arrival time associated with the first periodic burst transmission.

At 750, the UE modem 203-b may output an indication of a burst arrival time associated with the first periodic burst transmission (e.g., via UAI for uplink traffic information). The UE modem 203-b may report the UAI for uplink traffic information based on the burst arrival time after de-jitter buffering. For example, the UE modem 203-b may report the burst arrival time to the RAN 202-b (e.g., via UAI for uplink traffic information or via a time sensitive communication (TSC) assistance information (TSCAI) message or a TSC assistance container (TSCAC) message message). The burst arrival time may be a shifted burst arrival time after the de-jitter buffering at 730.

At 755, the UE modem 203-b may output jitter information including an indication of the jitter window associated with the first periodic burst transmission (e.g., via UAI for uplink traffic information). The UE modem 203-b may report the UAI for uplink traffic information based on the jitter after de-jitter buffering. For example, the UE modem 203-b may report a remaining jitter to RAN 202-b (e.g., via a TSCAI or TSCAC message). The remaining jitter may include the jitter associated with periodic burst transmissions after the delay. For example, the remaining jitter may include a reduced jitter window spanning the remaining percentage of the jitter window (e.g., a portion of the jitter window after the threshold percentage of the jitter window).

At 760, the RAN 202-b may process the jitter information (e.g., via an AI model, a ML model, or a statistic algorithm) to extract learn the XR traffic pattern or other information from the jitter information. For example, the RAN 202-b may estimate the jitter window, the jitter information, or the burst arrival time based on receiving one or more previous periodic burst transmissions.

At 765, the UE modem 203-b may obtain a configured grant based on the jitter window and the burst arrival time. Outputting the first periodic burst transmission may be based on the configured grant. For example, the RAN 202-b may configure one or more configured grants based on the XR traffic pattern of UAI message (e.g., based on the remaining jitter and the burst arrival time indicated via a UAI message). For example, the RAN 202-b may allocate configured grants to the UE 115-b based on a burst arrival time, a remaining jitter, or a jitter window associated with the XR traffic. A quantity of consecutive configured grant resources may be set based on the burst arrival time or the jitter information (e.g., remaining jitter) indicated via the UAI for uplink traffic information or estimated by the RAN 202-b. The RAN 202-b may set configured grant offsets based on the burst arrival time or jitter information indicated via the UAI for uplink traffic information or estimated by the RAN 202-b. For example, the offset of each configured grant resource may be set based on the shifted burst arrival time and remaining jitter. The RAN 202-b may reduce the quantity of configured grants based on the burst arrival time and jitter information. For example, the RAN 202-b may configure a reduced quantity of configured grants based on the UE modem 203-a delaying the periodic burst transmissions, as described with reference to FIG. 4. The RAN 202-a may transmit an indication of the configured grants to the UE 115-b, and the UE 115-b may perform a wake up procedure prior to the configured grants (e.g., the UE 115-b may wake late for the reduced quantity of configured grants).

At 770, the UE modem 203-b may output the first periodic burst transmission based on expiration of the first duration and prior to the first delivery deadline. For example, the UE modem 203-a may transmit the PDU set prior to expiration of the PSDB. The PDU sets may be delivered to the AS 215 prior to the delivery deadline, as described with reference to FIG. 4.

In some cases, the UE modem 203-b may output an indication of a DSR value associated with the first periodic burst transmission. The UE modem 203-b may report the DSR based on the de-jitter buffering at 730. The DSR value may indicate the one or more PDU sets arrived at a transmission buffer of the UE 115-c after buffering the one or more PDU sets.

For example, the UE modem 203-b may report a remaining time via a DSR after performing the buffering at 730 (e.g., the de-jitter buffering feature). The DSR may include a remaining time field. The remaining time field may indicate a shortest remaining value of a PDCP discard timer. The UE modem 203-b may calculate the remaining time based on an assumption that the first periodic burst transmission arrived at a transmission buffer of the UE modem 203-b after the de-jitter buffering. For example, the duration the first periodic burst transmission is delayed by the UE modem 203-b may not be removed from the PDCP discard timer. The RAN 202-b may not discard the delayed uplink packets due to updated (e.g., wrong) DSR report.

The techniques described herein for buffering at the UE modem 203-b may reduce the jitter associated with frame generation and encoding time and the jitter associated with the packet delivery between the AC 201-b and the UE modem 203-b. The de-jitter procedure described with reference to FIG. 7 may be transparent to the AC 201-b.

Although the techniques described herein are initially described in the context of delaying or buffer the periodic burst transmission until a threshold percentile of the jitter window, the UE 115 (e.g., the AC 201 or the UE modem 203), the AS 215, or the RAN 202 may utilize any methodology to restrict the range of jitter associated with periodic burst transmissions. Although described in the context of 5G communications systems, the techniques described herein may be applied to other communication technologies, such as Wi-Fi. Additionally, the techniques described herein may be implemented by RAN intelligence (e.g., RAN Intelligent Controller (RIC)), where the RIC may identify a jitter window of a communication flow and initiate the techniques described herein according to the identified jitter window and other parameters.

Assistance information may support the burst arrival time de-jitter buffering feature. The AC 201 may provide assistance information to the UE 115 (e.g., the UE modem 203). For example, the AC 201 may indicate whether a flow is compatible with BAT de-jitter buffering or indicate the deadline of a flow. The AS 215, the AC 201, UPF 205, a 5G core, the RAN 202, and the UE 115 (e.g., the UE modem 203) may share the assistance information to with each other. The assistance information may indicate de-jitter buffering as enabled or disabled, a de-jitter buffering percentile, a remaining jitter, a measured jitter statistic, or a measured generation time.

In some cases, a UAI for uplink traffic information may include additional jitter. For example, the UAI for uplink traffic information may indicate the de-jittered traffic statistic. The UAI may include a burst arrival time de-jitter buffering indication or an indication of a burst arrival time de-jitter buffering percentile (x-%). The RAN 202 may expect that the indicated percentile of periodic burst transmission (e.g., frames or PDU Sets) may arrive at the percentile (e.g., x-% jitter timing). The RAN 202 may provide configured grants based on the indicated percentile, which may increase communication efficiency.

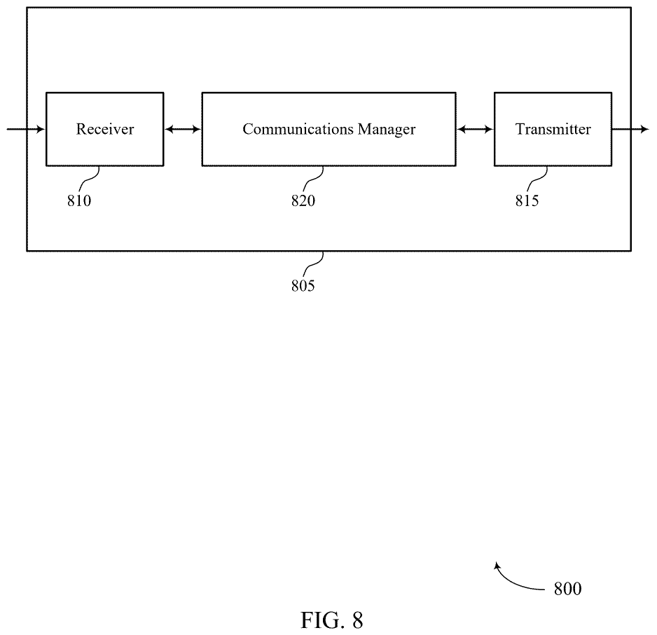

FIG. 8 shows a block diagram 800 of a device 805 that supports mitigating jitter in uplink communications in accordance with one or more aspects of the present disclosure. The device 805 may be an example of aspects of a wireless device as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of mitigating jitter in uplink communications as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for generating one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The communications manager 820 is capable of, configured to, or operable to support a means for buffing the one or more PDU sets for a first duration of the jitter window, where the first duration corresponds to a threshold percentage of the jitter window. The communications manager 820 is capable of, configured to, or operable to support a means for outputting the one or more PDU sets based on expiration of the first duration and prior to the first delivery deadline.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, more efficient utilization of communication resources, and the like.

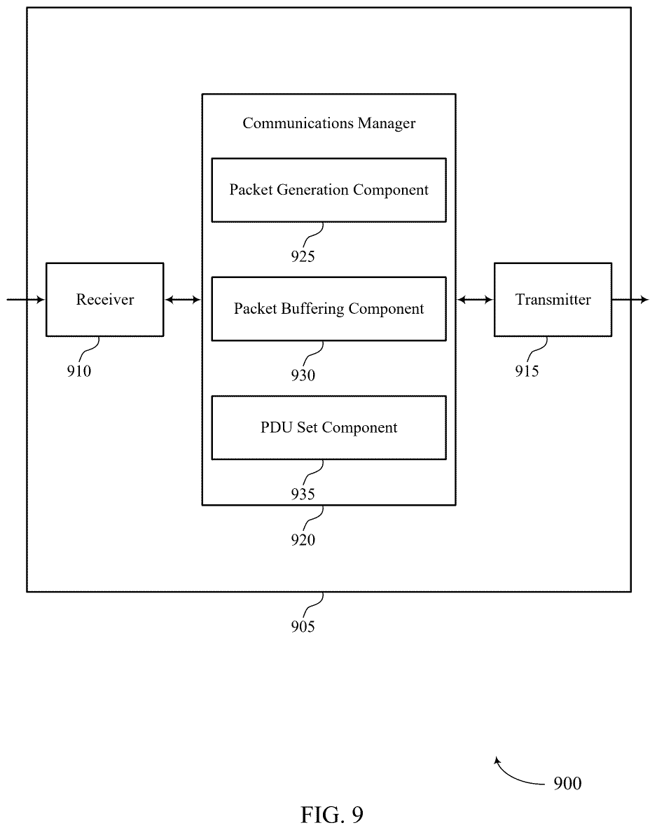

FIG. 9 shows a block diagram 900 of a device 905 that supports mitigating jitter in uplink communications in accordance with one or more aspects of the present disclosure. The device 905 may be an example of aspects of a device 805 or a wireless device (e.g., a UE 115 or a AC 201) as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of mitigating jitter in uplink communications as described herein. For example, the communications manager 920 may include a Packet Generation Component 925, a Packet Buffering Component 930, a PDU Set Component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The Packet Generation Component 925 is capable of, configured to, or operable to support a means for generating one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The Packet Buffering Component 930 is capable of, configured to, or operable to support a means for buffering the one or more PDU sets for a first duration of the jitter window, where the first duration corresponds to a threshold percentage of the jitter window. The PDU Set Component 935 is capable of, configured to, or operable to support a means for outputting the one or more PDU sets based on expiration of the first duration and prior to the first delivery deadline.

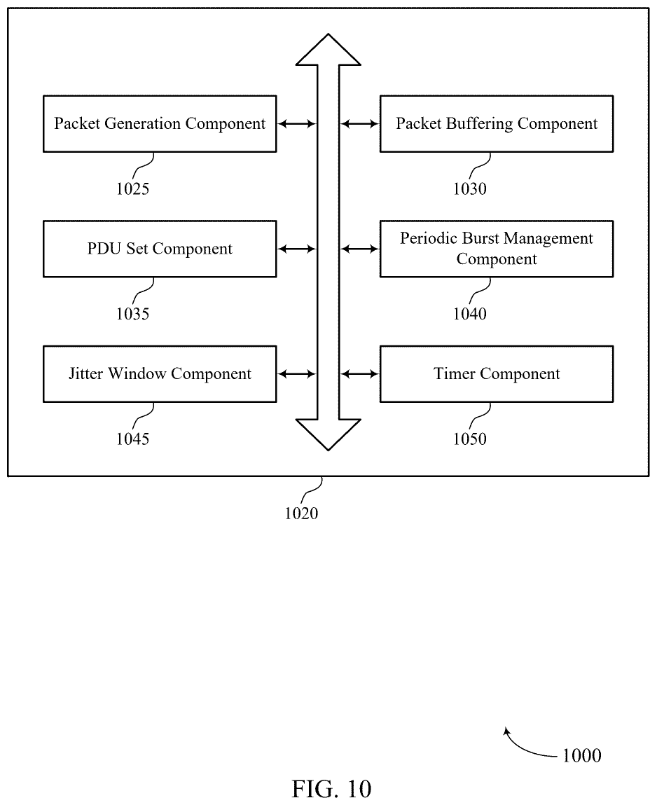

FIG. 10 shows a block diagram 1000 of a communications manager 1020 that supports mitigating jitter in uplink communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of mitigating jitter in uplink communications as described herein. For example, the communications manager 1020 may include a Packet Generation Component 1025, a Packet Buffering Component 1030, a PDU Set Component 1035, a Periodic Burst Management Component 1040, a Jitter Window Component 1045, a Timer Component 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The Packet Generation Component 1025 is capable of, configured to, or operable to support a means for generating one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The Packet Buffering Component 1030 is capable of, configured to, or operable to support a means for buffering the one or more PDU sets for a first duration of the jitter window, where the first duration corresponds to a threshold percentage of the jitter window. The PDU Set Component 1035 is capable of, configured to, or operable to support a means for outputting the one or more PDU sets based on expiration of the first duration and prior to the first delivery deadline.

In some examples, the Periodic Burst Management Component 1040 is capable of, configured to, or operable to support a means for obtaining an indication that a set of periodic burst transmissions associated with a data flow are consumed by the AS at a set of periodic delivery deadlines, the set of periodic burst transmissions including the first periodic burst transmission, and the set of periodic delivery deadlines including the first delivery deadline.

In some examples, the Periodic Burst Management Component 1040 is capable of, configured to, or operable to support a means for outputting an indication of the jitter window and an indication of a burst arrival time associated with the first periodic burst transmission.

In some examples, the Jitter Window Component 1045 is capable of, configured to, or operable to support a means for estimating the jitter window associated with the first periodic burst transmission based on a reference table and communication conditions.

In some examples, the Jitter Window Component 1045 is capable of, configured to, or operable to support a means for measuring a set of multiple jitter windows and a corresponding set of multiple communication conditions associated with communication of a set of multiple periodic burst transmissions, the set of multiple periodic burst transmissions being prior to the first periodic burst transmission, where the reference table is based on the set of multiple jitter windows and the corresponding set of multiple communication conditions.

In some examples, the Jitter Window Component 1045 is capable of, configured to, or operable to support a means for measuring one or more jitter windows associated with communication of one or more additional periodic burst transmissions and one or more communication conditions associated with the communication of the one or more additional periodic burst transmissions, the one or more additional periodic burst transmissions being after the set of multiple periodic burst transmissions. In some examples, the Jitter Window Component 1045 is capable of, configured to, or operable to support a means for updating the reference table based on measuring the one or more jitter windows and the one or more communication conditions, where estimating the jitter window is based on updating the reference table.

In some examples, the communication conditions includes an operating condition of the AS, a data rate of the first periodic burst transmission, a periodicity associated with the first periodic burst transmission, or any combination thereof.

In some examples, the Jitter Window Component 1045 is capable of, configured to, or operable to support a means for measuring a duration associated with generating the one or more PDU sets of the first periodic burst transmission. In some examples, the Jitter Window Component 1045 is capable of, configured to, or operable to support a means for estimating the jitter window based on the duration associated with generating the one or more PDU sets.

In some examples, the Jitter Window Component 1045 is capable of, configured to, or operable to support a means for measuring one or more jitter windows associated with communication of one or more periodic burst transmissions, the one or more periodic burst transmissions being prior to the first periodic burst transmission. In some examples, the Jitter Window Component 1045 is capable of, configured to, or operable to support a means for measuring a duration associated with generating the one or more PDU sets of the first periodic burst transmission. In some examples, the Jitter Window Component 1045 is capable of, configured to, or operable to support a means for estimating the jitter window based on the duration associated with generating the one or more PDU sets, a reference table, and communication conditions.

In some examples, the Timer Component 1050 is capable of, configured to, or operable to support a means for starting a timer in response to obtaining the one or more PDU sets, the timer being set to the first duration, where buffering the one or more PDU sets is based on starting the timer, and where outputting the first periodic burst transmission is based on expiration of the timer.

In some examples, the Timer Component 1050 is capable of, configured to, or operable to support a means for identifying a start time associated with the one or more PDU sets in response to obtaining the one or more PDU sets. In some examples, the Timer Component 1050 is capable of, configured to, or operable to support a means for delaying the one or more PDU sets from the start time for the first duration, where outputting the one or more PDU sets is based on the expiration of the first duration.

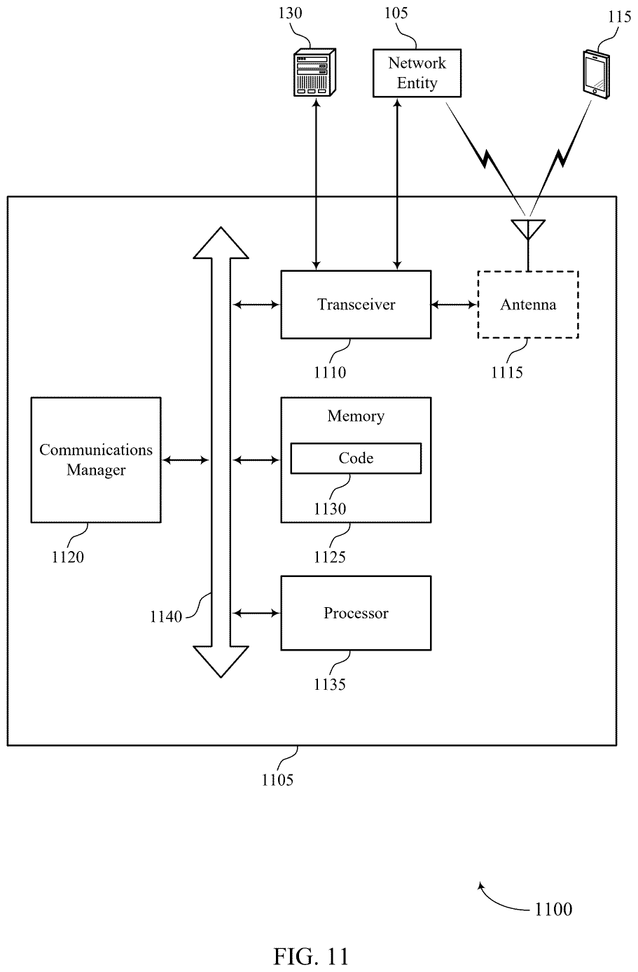

FIG. 11 shows a diagram of a system 1100 including a device 1105 that supports mitigating jitter in uplink communications in accordance with one or more aspects of the present disclosure. The device 1105 may be an example of or include components of a device 805, a device 905, or a wireless device as described herein. The device 1105 may include components for bi-directional voice and data communications including components for transmitting and receiving communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some implementations, the code 1130 may not be directly executable by a processor of the at least one processor 1135 but may cause a computer (e.g., when compiled and executed) to perform functions described herein. In some implementations, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some implementations, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting mitigating jitter in uplink communications). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for generating one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The communications manager 1120 is capable of, configured to, or operable to support a means for buffing the one or more PDU sets for a first duration of the jitter window, where the first duration corresponds to a threshold percentage of the jitter window. The communications manager 1120 is capable of, configured to, or operable to support a means for outputting the one or more PDU sets based on expiration of the first duration and prior to the first delivery deadline.

By including or configuring the communications manager 1120 in accordance with examples as described herein, the device 1105 may support techniques for reduced power consumption, more efficient utilization of communication resources, improved coordination between devices, longer battery life, and the like.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of mitigating jitter in uplink communications as described herein, or the at least one processor 1135 and the at least one memory 1125 may be otherwise configured to, individually or collectively, perform or support such operations.

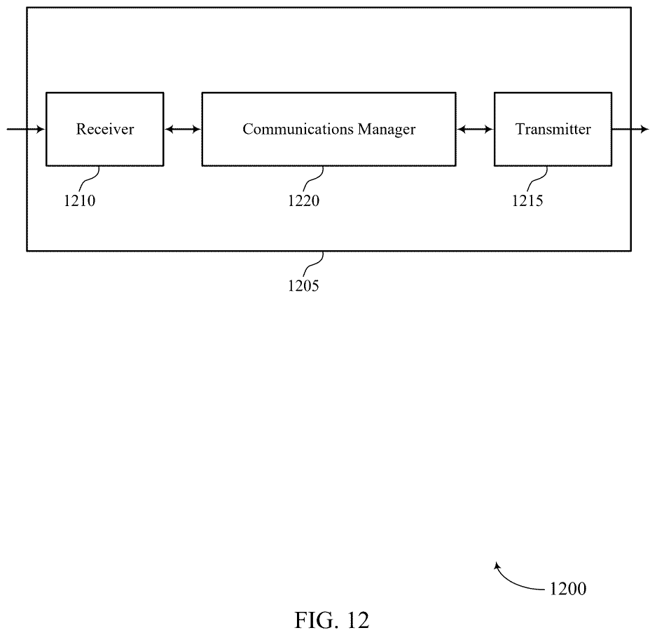

FIG. 12 shows a block diagram 1200 of a device 1205 that supports mitigating jitter in uplink communications in accordance with one or more aspects of the present disclosure. The device 1205 may be an example of aspects of a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to mitigating jitter in uplink communications). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to mitigating jitter in uplink communications). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations or components thereof may be examples of means for performing various aspects of mitigating jitter in uplink communications as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for obtaining one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The communications manager 1220 is capable of, configured to, or operable to support a means for buffing the one or more PDU sets for a first duration of the jitter window, where the first duration corresponds to a threshold percentage of the jitter window. The communications manager 1220 is capable of, configured to, or operable to support a means for outputting the first periodic burst transmission based on expiration of the first duration and prior to the first delivery deadline.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, more efficient utilization of communication resources, and the like.

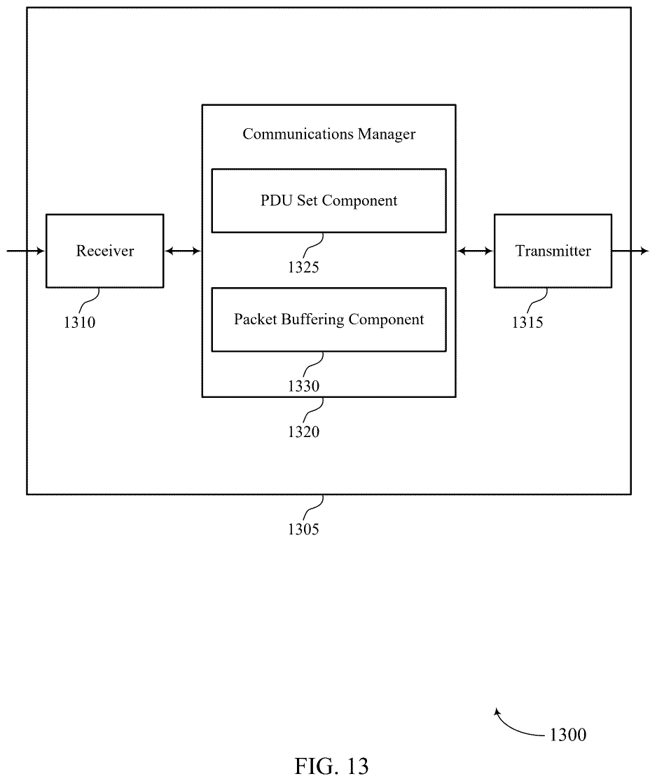

FIG. 13 shows a block diagram 1300 of a device 1305 that supports mitigating jitter in uplink communications in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to mitigating jitter in uplink communications). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to mitigating jitter in uplink communications). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of mitigating jitter in uplink communications as described herein. For example, the communications manager 1320 may include a PDU Set Component 1325 a Packet Buffering Component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The PDU Set Component 1325 is capable of, configured to, or operable to support a means for obtaining one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The Packet Buffering Component 1330 is capable of, configured to, or operable to support a means for buffering the one or more PDU sets for a first duration of the jitter window, where the first duration corresponds to a threshold percentage of the jitter window. The PDU Set Component 1325 is capable of, configured to, or operable to support a means for outputting the first periodic burst transmission based on expiration of the first duration and prior to the first delivery deadline.

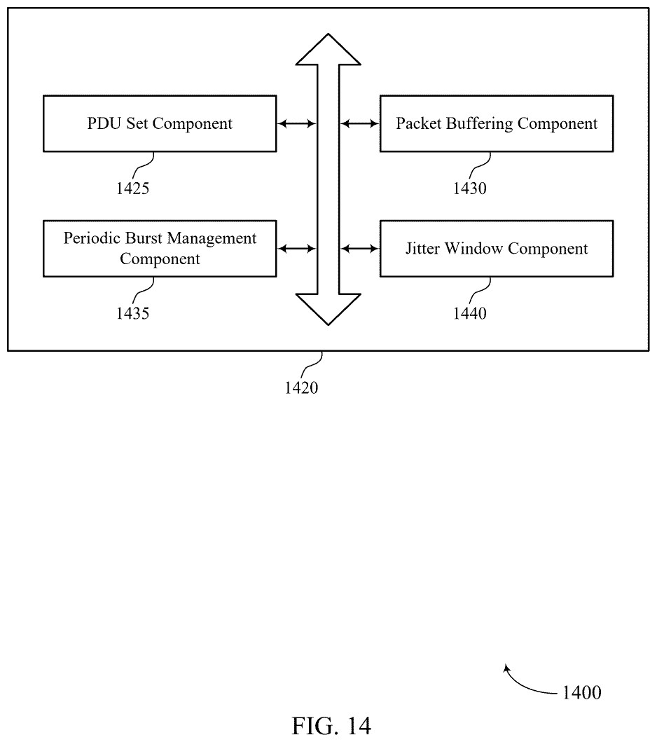

FIG. 14 shows a block diagram 1400 of a communications manager 1420 that supports mitigating jitter in uplink communications in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of mitigating jitter in uplink communications as described herein. For example, the communications manager 1420 may include a PDU Set Component 1425, a Packet Buffering Component 1430, a Periodic Burst Management Component 1435, a Jitter Window Component 1440, or any combination thereof. Each of these components, or components or subcomponents thereof (e.g., one or more processors, one or more memories), may communicate, directly or indirectly, with one another (e.g., via one or more buses).

The communications manager 1420 may support wireless communications in accordance with examples as disclosed herein. The PDU Set Component 1425 is capable of, configured to, or operable to support a means for obtaining one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The Packet Buffering Component 1430 is capable of, configured to, or operable to support a means for buffering the one or more PDU sets for a first duration of the jitter window, where the first duration corresponds to a threshold percentage of the jitter window. In some examples, the PDU Set Component 1425 is capable of, configured to, or operable to support a means for outputting the first periodic burst transmission based on expiration of the first duration and prior to the first delivery deadline.

In some examples, the Periodic Burst Management Component 1435 is capable of, configured to, or operable to support a means for obtaining an indication that a set of periodic burst transmissions associated with a data flow are consumed by the AS at a set of periodic delivery deadlines, the set of periodic burst transmissions including the first periodic burst transmission, and the set of periodic delivery deadlines including the first delivery deadline.

In some examples, the Periodic Burst Management Component 1435 is capable of, configured to, or operable to support a means for outputting an indication of the jitter window and an indication of a burst arrival time associated with the first periodic burst transmission. In some examples, the Periodic Burst Management Component 1435 is capable of, configured to, or operable to support a means for obtaining a configured grant based on the jitter window and the burst arrival time, where outputting the first periodic burst transmission is based on the configured grant.

In some examples, the Periodic Burst Management Component 1435 is capable of, configured to, or operable to support a means for outputting an indication of a delay status report value associated with the first periodic burst transmission, where the delay status report value indicates the one or more PDU sets arrived at a transmission buffer of the UE after buffering the one or more PDU sets.

In some examples, the Jitter Window Component 1440 is capable of, configured to, or operable to support a means for estimating the jitter window associated with the first periodic burst transmission based on a reference table and communication conditions.

In some examples, the Jitter Window Component 1440 is capable of, configured to, or operable to support a means for measuring a set of multiple jitter windows and a corresponding set of multiple communication conditions associated with communication of a set of multiple periodic burst transmissions, the set of multiple periodic burst transmissions being prior to the first periodic burst transmission, where the reference table is based on the set of multiple jitter windows and the corresponding set of multiple communication conditions.

In some examples, the Jitter Window Component 1440 is capable of, configured to, or operable to support a means for measuring a duration associated with generating the one or more PDU sets of the first periodic burst transmission. In some examples, the Jitter Window Component 1440 is capable of, configured to, or operable to support a means for estimating the jitter window based on the duration associated with generating the one or more PDU sets.

In some examples, the Jitter Window Component 1440 is capable of, configured to, or operable to support a means for measuring one or more jitter windows associated with communication of one or more periodic burst transmissions, the one or more periodic burst transmissions being prior to the first periodic burst transmission. In some examples, the Jitter Window Component 1440 is capable of, configured to, or operable to support a means for measuring a duration associated with generating the one or more PDU sets of the first periodic burst transmission. In some examples, the Jitter Window Component 1440 is capable of, configured to, or operable to support a means for estimating the jitter window based on the duration associated with generating the one or more PDU sets, a reference table, and communication conditions.

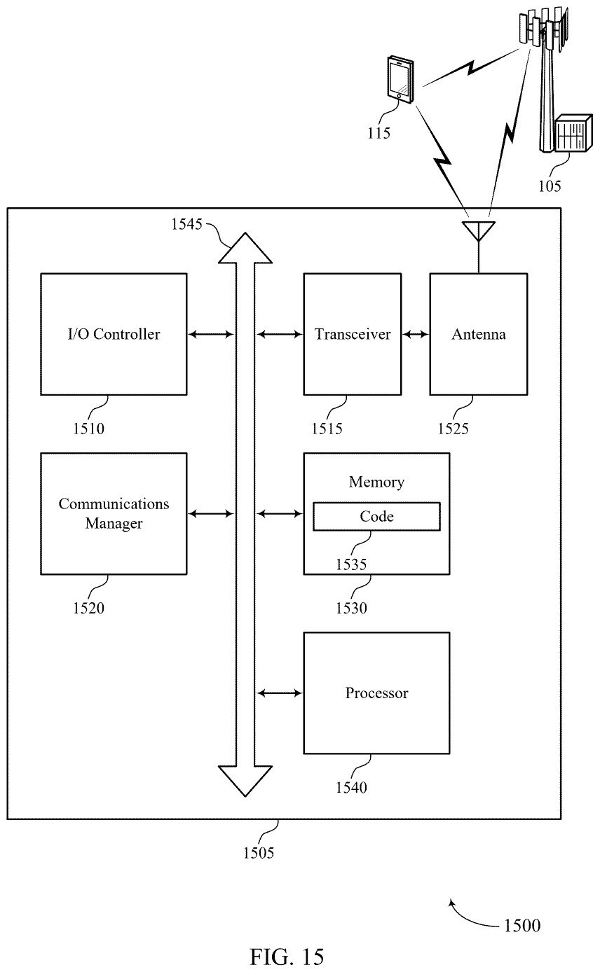

FIG. 15 shows a diagram of a system 1500 including a device 1505 that supports mitigating jitter in uplink communications in accordance with one or more aspects of the present disclosure. The device 1505 may be an example of or include components of a device 1205, a device 1305, or a UE 115 as described herein. The device 1505 may communicate (e.g., wirelessly) with one or more other devices (e.g., network entities 105, UEs 115, or a combination thereof). The device 1505 may include components for bi-directional voice and data communications including components for transmitting and receiving communications, such as a communications manager 1520, an input/output (I/O) controller, such as an I/O controller 1510, a transceiver 1515, one or more antennas 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some implementations, the I/O controller 1510 may represent a physical connection or port to an external peripheral. In some implementations, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some implementations, the I/O controller 1510 may be implemented as part of one or more processors, such as the at least one processor 1540. In some implementations, a user may interact with the device 1505 via the I/O controller 1510 or via hardware components controlled by the I/O controller 1510.

In some implementations, the device 1505 may include a single antenna. However, in some other cases, the device 1505 may have more than one antenna, which may be capable of concurrently transmitting or receiving multiple wireless transmissions. The transceiver 1515 may communicate bi-directionally via the one or more antennas 1525 using wired or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include random access memory (RAM) and read-only memory (ROM). The at least one memory 1530 may store computer-readable, computer-executable, or processor-executable code, such as the code 1535. The code 1535 may include instructions that, when executed by the at least one processor 1540, cause the device 1505 to perform various functions described herein. The code 1535 may be stored in a non-transitory computer-readable medium such as system memory or another type of memory. In some implementations, the code 1535 may not be directly executable by the at least one processor 1540 but may cause a computer (e.g., when compiled and executed) to perform functions described herein. In some implementations, the at least one memory 1530 may include, among other things, a basic I/O system (BIOS) which may control basic hardware or software operation such as the interaction with peripheral components or devices.

The at least one processor 1540 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some implementations, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting mitigating jitter in uplink communications). For example, the device 1505 or a component of the device 1505 may include at least one processor 1540 and at least one memory 1530 coupled with or to the at least one processor 1540, the at least one processor 1540 and the at least one memory 1530 configured to perform various functions described herein.

In some examples, the at least one processor 1540 may include multiple processors and the at least one memory 1530 may include multiple memories. One or more of the multiple processors may be coupled with one or more of the multiple memories, which may, individually or collectively, be configured to perform various functions described herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. For example, the at least one processor 1540 or a processing system including the at least one processor 1540 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code 1535 (e.g., processor-executable code) stored in the at least one memory 1530 or otherwise, to perform one or more of the functions described herein.

The communications manager 1520 may support wireless communications in accordance with examples as disclosed herein. For example, the communications manager 1520 is capable of, configured to, or operable to support a means for obtaining one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The communications manager 1520 is capable of, configured to, or operable to support a means for buffing the one or more PDU sets for a first duration of the jitter window, where the first duration corresponds to a threshold percentage of the jitter window. The communications manager 1520 is capable of, configured to, or operable to support a means for outputting the first periodic burst transmission based on expiration of the first duration and prior to the first delivery deadline.

By including or configuring the communications manager 1520 in accordance with examples as described herein, the device 1505 may support techniques for reduced power consumption, more efficient utilization of communication resources, improved coordination between devices, longer battery life, and the like.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of mitigating jitter in uplink communications as described herein, or the at least one processor 1540 and the at least one memory 1530 may be otherwise configured to, individually or collectively, perform or support such operations.

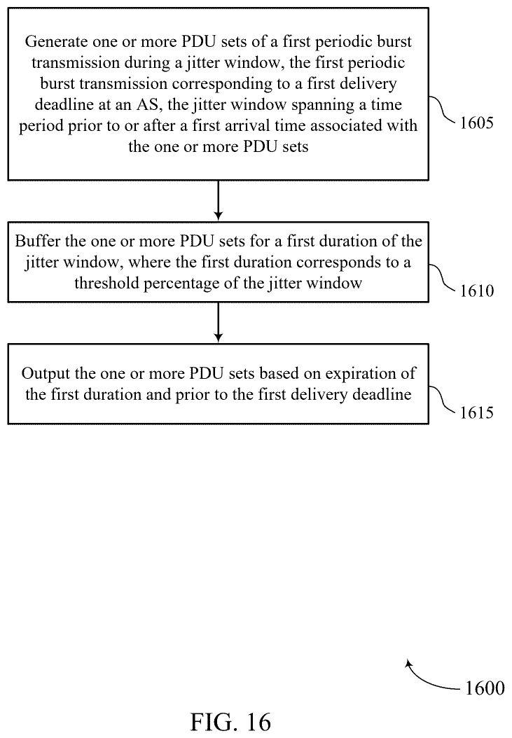

FIG. 16 shows a flowchart illustrating a method 1600 that supports mitigating jitter in uplink communications in accordance with one or more aspects of the present disclosure. The operations of the method 1600 may be implemented by a wireless device or its components as described herein. For example, the operations of the method 1600 may be performed by a wireless device as described with reference to FIGS. 1 through 11. In some examples, a wireless device may execute a set of instructions to control the functional elements of the wireless device to perform the described functions. Additionally, or alternatively, the wireless device may perform aspects of the described functions using special-purpose hardware.

At 1605, the method may include generating one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The operations of 1605 may be performed in accordance with examples as disclosed herein, such as disclosed in operation 515 of FIG. 5. In some examples, aspects of the operations of 1605 may be performed by a Packet Generation Component 1025 as described with reference to FIG. 10.

At 1610, the method may include buffering the one or more PDU sets for a first duration of the jitter window, where the first duration corresponds to a threshold percentage of the jitter window. The operations of 1610 may be performed in accordance with examples as disclosed herein, such as disclosed in operation 520 of FIG. 5. In some examples, aspects of the operations of 1610 may be performed by a Packet Buffering Component 1030 as described with reference to FIG. 10.

At 1615, the method may include outputting the one or more PDU sets based on expiration of the first duration and prior to the first delivery deadline. The operations of 1615 may be performed in accordance with examples as disclosed herein, such as disclosed in operation 525 of FIG. 5. In some examples, aspects of the operations of 1615 may be performed by a PDU Set Component 1035 as described with reference to FIG. 10.

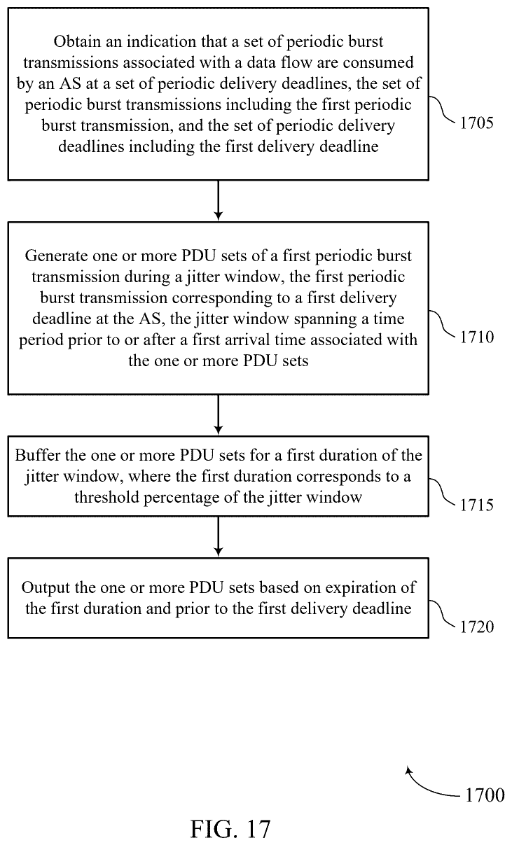

FIG. 17 shows a flowchart illustrating a method 1700 that supports mitigating jitter in uplink communications in accordance with one or more aspects of the present disclosure. The operations of the method 1700 may be implemented by a wireless device or its components as described herein. For example, the operations of the method 1700 may be performed by a wireless device as described with reference to FIGS. 1 through 11. In some examples, a wireless device may execute a set of instructions to control the functional elements of the wireless device to perform the described functions. Additionally, or alternatively, the wireless device may perform aspects of the described functions using special-purpose hardware.

At 1705, the method may include obtaining an indication that a set of periodic burst transmissions associated with a data flow are consumed by an AS at a set of periodic delivery deadlines, the set of periodic burst transmissions including the first periodic burst transmission, and the set of periodic delivery deadlines including the first delivery deadline. The operations of 1705 may be performed in accordance with examples as disclosed herein, such as disclosed in operation 505 of FIG. 5. In some examples, aspects of the operations of 1705 may be performed by a Periodic Burst Management Component 1040 as described with reference to FIG. 10.

At 1710, the method may include generating one or more PDU sets of a first periodic burst transmission during a jitter window, the first periodic burst transmission corresponding to a first delivery deadline at the AS, the jitter window spanning a time period prior to or after a first arrival time associated with the one or more PDU sets. The operations of 1710 may be performed in accordance with examples as disclosed herein, such as disclosed in operation 515 of FIG. 5. In some examples, aspects of the operations of 1710 may be performed by a Packet Generation Component 1025 as described with reference to FIG. 10.

At 1715, the method may include buffering the one or more PDU sets for a first duration of the jitter window, where the first duration corresponds to a threshold percentage of the jitter window. The operations of 1715 may be performed in accordance with examples as disclosed herein, such as disclosed in operation 520 of FIG. 5. In some examples, aspects of the operations of 1715 may be performed by a Packet Buffering Component 1030 as described with reference to FIG. 10.

At 1720, the method may include outputting the one or more PDU sets based on expiration of the first duration and prior to the first delivery deadline. The operations of 1720 may be performed in accordance with examples as disclosed herein, such as disclosed in operation 525 of FIG. 5. In some examples, aspects of the operations of 1720 may be performed by a PDU Set Component 1035 as described with reference to FIG. 10.

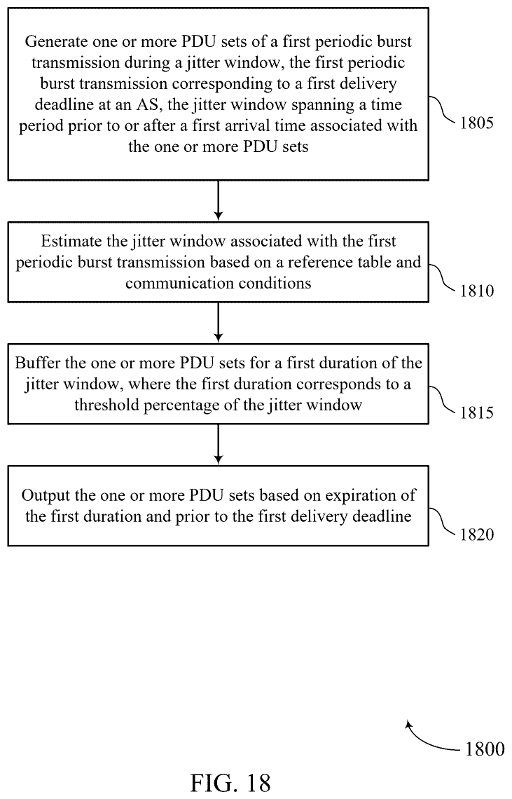

FIG. 18 shows a flowchart illustrating a method 1800 that supports mitigating jitter in uplink communications in accordance with one or more aspects of the present disclosure. The operations of the method 1800 may be implemented by a wireless device or its components as described herein. For example, the operations of the method 1800 may be performed by a wireless device as described with reference to FIGS. 1 through 11. In some examples, a wireless device may execute a set of instructions to control the functional elements of the wireless device to perform the described functions. Additionally, or alternatively, the wireless device may perform aspects of the described functions using special-purpose hardware.

At 1805, the method may include generating one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The operations of 1805 may be performed in accordance with examples as disclosed herein, such as disclosed in operation 515 of FIG. 5. In some examples, aspects of the operations of 1805 may be performed by a Packet Generation Component 1025 as described with reference to FIG. 10.

At 1810, the method may include estimating the jitter window associated with the first periodic burst transmission based on a reference table and communication conditions. The operations of 1810 may be performed in accordance with examples as disclosed herein, such as disclosed in operation 510 of FIG. 5. In some examples, aspects of the operations of 1810 may be performed by a Jitter Window Component 1045 as described with reference to FIG. 10.

At 1815, the method may include buffering the one or more PDU sets for a first duration of the jitter window, where the first duration corresponds to a threshold percentage of the jitter window. The operations of 1815 may be performed in accordance with examples as disclosed herein, such as disclosed in operation 520 of FIG. 5. In some examples, aspects of the operations of 1815 may be performed by a Packet Buffering Component 1030 as described with reference to FIG. 10.

At 1820, the method may include outputting the one or more PDU sets based on expiration of the first duration and prior to the first delivery deadline. The operations of 1820 may be performed in accordance with examples as disclosed herein, such as disclosed in operation 525 of FIG. 5. In some examples, aspects of the operations of 1820 may be performed by a PDU Set Component 1035 as described with reference to FIG. 10.

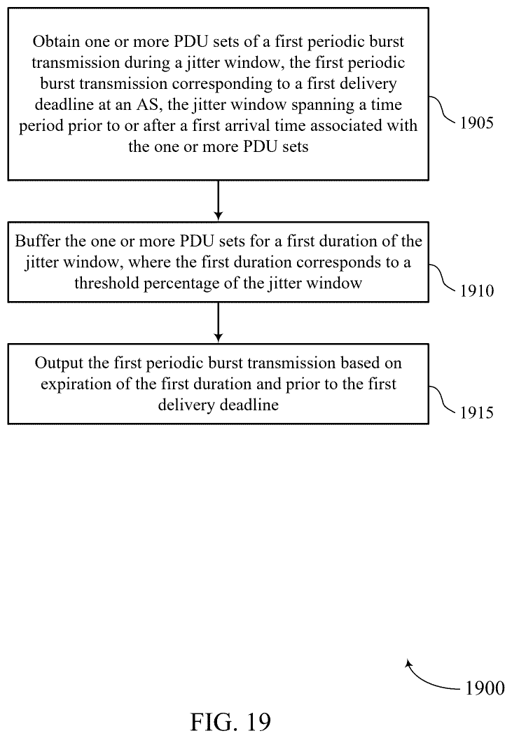

FIG. 19 shows a flowchart illustrating a method 1900 that supports mitigating jitter in uplink communications in accordance with one or more aspects of the present disclosure. The operations of the method 1900 may be implemented by a UE or its components as described herein. For example, the operations of the method 1900 may be performed by a UE 115 as described with reference to FIGS. 1 through 7 and 12 through 15. In some examples, a UE may execute a set of instructions to control the functional elements of the UE to perform the described functions. Additionally, or alternatively, the UE may perform aspects of the described functions using special-purpose hardware.

At 1905, the method may include obtaining one or more PDU sets of a first periodic burst transmission during a jitter window, the first periodic burst transmission corresponding to a first delivery deadline at an AS, the jitter window spanning a time period prior to or after a first arrival time associated with the one or more PDU sets. The operations of 1905 may be performed in accordance with examples as disclosed herein, such as disclosed in operation 715 of FIG. 7. In some examples, aspects of the operations of 1905 may be performed by a PDU Set Component 1425 as described with reference to FIG. 14.

At 1910, the method may include buffering the one or more PDU sets for a first duration of the jitter window, where the first duration corresponds to a threshold percentage of the jitter window. The operations of 1910 may be performed in accordance with examples as disclosed herein, such as disclosed in operation 730 of FIG. 7. In some examples, aspects of the operations of 1910 may be performed by a Packet Buffering Component 1430 as described with reference to FIG. 14.

At 1915, the method may include outputting the first periodic burst transmission based on expiration of the first duration and prior to the first delivery deadline. The operations of 1915 may be performed in accordance with examples as disclosed herein, such as disclosed in operation 770 of FIG. 7. In some examples, aspects of the operations of 1915 may be performed by a PDU Set Component 1425 as described with reference to FIG. 14.

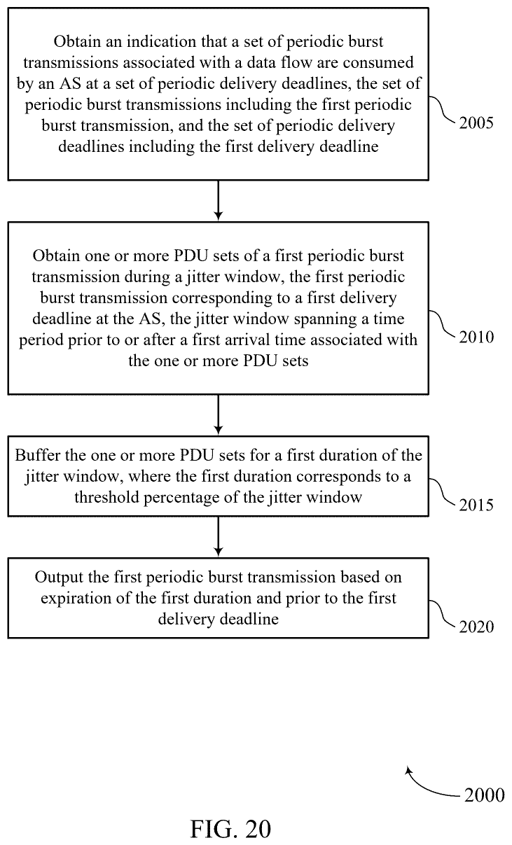

FIG. 20 shows a flowchart illustrating a method 2000 that supports mitigating jitter in uplink communications in accordance with one or more aspects of the present disclosure. The operations of the method 2000 may be implemented by a UE or its components as described herein. For example, the operations of the method 2000 may be performed by a UE 115 as described with reference to FIGS. 1 through 7 and 12 through 15. In some examples, a UE may execute a set of instructions to control the functional elements of the UE to perform the described functions. Additionally, or alternatively, the UE may perform aspects of the described functions using special-purpose hardware.

At 2005, the method may include obtaining an indication that a set of periodic burst transmissions associated with a data flow are consumed by an AS at a set of periodic delivery deadlines, the set of periodic burst transmissions including the first periodic burst transmission, and the set of periodic delivery deadlines including the first delivery deadline. The operations of 2005 may be performed in accordance with examples as disclosed herein, such as disclosed in operation 705 of FIG. 7. In some examples, aspects of the operations of 2005 may be performed by a Periodic Burst Management Component 1435 as described with reference to FIG. 14.

At 2010, the method may include obtaining one or more PDU sets of a first periodic burst transmission during a jitter window, the first periodic burst transmission corresponding to a first delivery deadline at the AS, the jitter window spanning a time period prior to or after a first arrival time associated with the one or more PDU sets. The operations of 2010 may be performed in accordance with examples as disclosed herein, such as disclosed in operation 715 of FIG. 7. In some examples, aspects of the operations of 2010 may be performed by a PDU Set Component 1425 as described with reference to FIG. 14.

At 2015, the method may include buffering the one or more PDU sets for a first duration of the jitter window, where the first duration corresponds to a threshold percentage of the jitter window. The operations of 2015 may be performed in accordance with examples as disclosed herein, such as disclosed in operation 730 of FIG. 7. In some examples, aspects of the operations of 2015 may be performed by a Packet Buffering Component 1430 as described with reference to FIG. 14.

At 2020, the method may include outputting the first periodic burst transmission based on expiration of the first duration and prior to the first delivery deadline. The operations of 2020 may be performed in accordance with examples as disclosed herein, such as disclosed in operation 770 of FIG. 7. In some examples, aspects of the operations of 2020 may be performed by a PDU Set Component 1425 as described with reference to FIG. 14.

The following provides an overview of aspects of the present disclosure:

Aspect 1: A method by a wireless device, comprising: generating one or more PDU sets of a first periodic burst transmission during a jitter window, the first periodic burst transmission corresponding to a first delivery deadline at an AS, the jitter window spanning a time period prior to or after a first arrival time associated with the one or more PDU sets; buffing the one or more PDU sets for a first duration of the jitter window, wherein the first duration corresponds to a threshold percentage of the jitter window; and outputting the one or more PDU sets based at least in part on expiration of the first duration and prior to the first delivery deadline.

Aspect 2: The method of aspect 1, further comprising: obtaining an indication that a set of periodic burst transmissions associated with a data flow are consumed by the AS at a set of periodic delivery deadlines, the set of periodic burst transmissions comprising the first periodic burst transmission, and the set of periodic delivery deadlines comprising the first delivery deadline.

Aspect 3: The method of any of aspects 1 through 2, further comprising: outputting an indication of the jitter window and an indication of a burst arrival time associated with the first periodic burst transmission.

Aspect 4: The method of any of aspects 1 through 3, further comprising: estimating the jitter window associated with the first periodic burst transmission based at least in part on a reference table and communication conditions.

Aspect 5: The method of aspect 4, further comprising: measuring a plurality of jitter windows and a corresponding plurality of communication conditions associated with communication of a plurality of periodic burst transmissions, the plurality of periodic burst transmissions being prior to the first periodic burst transmission, wherein the reference table is based at least in part on the plurality of jitter windows and the corresponding plurality of communication conditions.

Aspect 6: The method of aspect 5, further comprising: measuring one or more jitter windows associated with communication of one or more additional periodic burst transmissions and one or more communication conditions associated with the communication of the one or more additional periodic burst transmissions, the one or more additional periodic burst transmissions being after the plurality of periodic burst transmissions; and updating the reference table based at least in part on measuring the one or more jitter windows and the one or more communication conditions, wherein estimating the jitter window is based at least in part on updating the reference table.

Aspect 7: The method of any of aspects 4 through 6, wherein the communication conditions comprises an operating condition of the AS, a data rate of the first periodic burst transmission, a periodicity associated with the first periodic burst transmission, or any combination thereof.

Aspect 8: The method of any of aspects 1 through 3, further comprising: measuring a duration associated with generating the one or more PDU sets of the first periodic burst transmission; and estimating the jitter window based at least in part on the duration associated with generating the one or more PDU sets.

Aspect 9: The method of any of aspects 1 through 3, further comprising: measuring one or more jitter windows associated with communication of one or more periodic burst transmissions, the one or more periodic burst transmissions being prior to the first periodic burst transmission; measuring a duration associated with generating the one or more PDU sets of the first periodic burst transmission; and estimating the jitter window based at least in part on the duration associated with generating the one or more PDU sets, a reference table, and communication conditions.

Aspect 10: The method of any of aspects 1 through 9, further comprising: starting a timer in response to obtaining the one or more PDU sets, the timer being set to the first duration, wherein buffering the one or more PDU sets is based at least in part on starting the timer, and wherein outputting the first periodic burst transmission is based at least in part on expiration of the timer.

Aspect 11: The method of any of aspects 1 through 9, further comprising: identifying a start time associated with the one or more PDU sets in response to obtaining the one or more PDU sets; and delaying the one or more PDU sets from the start time for the first duration, wherein outputting the one or more PDU sets is based at least in part on the expiration of the first duration.

Aspect 12: A method by a UE, comprising: obtaining one or more PDU sets of a first periodic burst transmission during a jitter window, the first periodic burst transmission corresponding to a first delivery deadline at an AS, the jitter window spanning a time period prior to or after a first arrival time associated with the one or more PDU sets; buffing the one or more PDU sets for a first duration of the jitter window, wherein the first duration corresponds to a threshold percentage of the jitter window; and outputting the first periodic burst transmission based at least in part on expiration of the first duration and prior to the first delivery deadline.

Aspect 13: The method of aspect 12, further comprising: obtaining an indication that a set of periodic burst transmissions associated with a data flow are consumed by the AS at a set of periodic delivery deadlines, the set of periodic burst transmissions comprising the first periodic burst transmission, and the set of periodic delivery deadlines comprising the first delivery deadline.

Aspect 14: The method of any of aspects 12 through 13, further comprising: outputting an indication of the jitter window and an indication of a burst arrival time associated with the first periodic burst transmission; and obtaining a configured grant based at least in part on the jitter window and the burst arrival time, wherein outputting the first periodic burst transmission is based at least in part on the configured grant.

Aspect 15: The method of any of aspects 12 through 14, further comprising: outputting an indication of a DSR value associated with the first periodic burst transmission, wherein the DSR value indicates the one or more PDU sets arrived at a transmission buffer of the UE after buffering the one or more PDU sets.

Aspect 16: The method of any of aspects 12 through 15, further comprising: estimating the jitter window associated with the first periodic burst transmission based at least in part on a reference table and communication conditions.

Aspect 17: The method of aspect 16, further comprising: measuring a plurality of jitter windows and a corresponding plurality of communication conditions associated with communication of a plurality of periodic burst transmissions, the plurality of periodic burst transmissions being prior to the first periodic burst transmission, wherein the reference table is based at least in part on the plurality of jitter windows and the corresponding plurality of communication conditions.

Aspect 18: The method of any of aspects 12 through 15, further comprising: measuring a duration associated with generating the one or more PDU sets of the first periodic burst transmission; and estimating the jitter window based at least in part on the duration associated with generating the one or more PDU sets.

Aspect 19: The method of any of aspects 12 through 15, further comprising: measuring one or more jitter windows associated with communication of one or more periodic burst transmissions, the one or more periodic burst transmissions being prior to the first periodic burst transmission; measuring a duration associated with generating the one or more PDU sets of the first periodic burst transmission; and estimating the jitter window based at least in part on the duration associated with generating the one or more PDU sets, a reference table, and communication conditions.

Aspect 20: A wireless device comprising one or more memories storing processor-executable code, and one or more processors coupled with the one or more memories and individually or collectively operable to execute the code to cause the wireless device to perform a method of any of aspects 1 through 11.

Aspect 21: A wireless device comprising at least one means for performing a method of any of aspects 1 through 11.

Aspect 22: A non-transitory computer-readable medium storing code the code comprising instructions executable by one or more processors to perform a method of any of aspects 1 through 11.

Aspect 23: A UE comprising one or more memories storing processor-executable code, and one or more processors coupled with the one or more memories and individually or collectively operable to execute the code to cause the UE to perform a method of any of aspects 12 through 19.

Aspect 24: A UE comprising at least one means for performing a method of any of aspects 12 through 19.

Aspect 25: A non-transitory computer-readable medium storing code the code comprising instructions executable by one or more processors to perform a method of any of aspects 12 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
generate one or more packet data unit (PDU) sets of a first periodic burst transmission during a jitter window, the first periodic burst transmission corresponding to a first delivery deadline at an application server, the jitter window spanning a time period prior to or after a first arrival time associated with the one or more PDU sets;
buffer the one or more PDU sets for a first duration of the jitter window, wherein the first duration corresponds to a threshold percentage of the jitter window; and
output the one or more PDU sets based at least in part on expiration of the first duration and prior to the first delivery deadline.

2. The wireless device of claim 1, wherein the one or more processors are individually or collectively further operable to execute the code to cause the wireless device to:
obtain an indication that a set of periodic burst transmissions associated with a data flow are consumed by the application server at a set of periodic delivery deadlines, the set of periodic burst transmissions comprising the first periodic burst transmission, and the set of periodic delivery deadlines comprising the first delivery deadline.

3. The wireless device of claim 1, wherein the one or more processors are individually or collectively further operable to execute the code to cause the wireless device to:
output an indication of the jitter window and an indication of a burst arrival time associated with the first periodic burst transmission.

4. The wireless device of claim 1, wherein the one or more processors are individually or collectively further operable to execute the code to cause the wireless device to:
estimate the jitter window associated with the first periodic burst transmission based at least in part on a reference table and communication conditions.

5. The wireless device of claim 4, wherein the one or more processors are individually or collectively further operable to execute the code to cause the wireless device to:
measure a plurality of jitter windows and a corresponding plurality of communication conditions associated with communication of a plurality of periodic burst transmissions, the plurality of periodic burst transmissions being prior to the first periodic burst transmission, wherein the reference table is based at least in part on the plurality of jitter windows and the corresponding plurality of communication conditions.

6. The wireless device of claim 5, wherein the one or more processors are individually or collectively further operable to execute the code to cause the wireless device to:
measure one or more jitter windows associated with communication of one or more additional periodic burst transmissions and one or more communication conditions associated with the communication of the one or more additional periodic burst transmissions, the one or more additional periodic burst transmissions being after the plurality of periodic burst transmissions; and
update the reference table based at least in part on measuring the one or more jitter windows and the one or more communication conditions, wherein estimating the jitter window is based at least in part on updating the reference table.

7. The wireless device of claim 4, wherein the communication conditions comprises an operating condition of the application server, a data rate of the first periodic burst transmission, a periodicity associated with the first periodic burst transmission, or any combination thereof.

8. The wireless device of claim 1, wherein the one or more processors are individually or collectively further operable to execute the code to cause the wireless device to:
measure a duration associated with generating the one or more PDU sets of the first periodic burst transmission; and
estimate the jitter window based at least in part on the duration associated with generating the one or more PDU sets.

9. The wireless device of claim 1, wherein the one or more processors are individually or collectively further operable to execute the code to cause the wireless device to:
measure one or more jitter windows associated with communication of one or more periodic burst transmissions, the one or more periodic burst transmissions being prior to the first periodic burst transmission;
measure a duration associated with generating the one or more PDU sets of the first periodic burst transmission; and
estimate the jitter window based at least in part on the duration associated with generating the one or more PDU sets, a reference table, and communication conditions.

10. The wireless device of claim 1, wherein the one or more processors are individually or collectively further operable to execute the code to cause the wireless device to:
start a timer in response to obtaining the one or more PDU sets, the timer being set to the first duration, wherein buffering the one or more PDU sets is based at least in part on starting the timer, and wherein outputting the first periodic burst transmission is based at least in part on expiration of the timer.

11. The wireless device of claim 1, wherein the one or more processors are individually or collectively further operable to execute the code to cause the wireless device to:
identify a start time associated with the one or more PDU sets in response to obtaining the one or more PDU sets; and
delay the one or more PDU sets from the start time for the first duration, wherein outputting the one or more PDU sets is based at least in part on the expiration of the first duration.

12. A user equipment (UE), comprising:
one or more memories storing processor-executable code; and
one or more processors coupled with the one or more memories and individually or collectively operable to execute the code to cause the UE to:
obtain one or more packet data unit (PDU) sets of a first periodic burst transmission during a jitter window, the first periodic burst transmission corresponding to a first delivery deadline at an application server, the jitter window spanning a time period prior to or after a first arrival time associated with the one or more PDU sets;
buffer the one or more PDU sets for a first duration of the jitter window, wherein the first duration corresponds to a threshold percentage of the jitter window; and
output the first periodic burst transmission based at least in part on expiration of the first duration and prior to the first delivery deadline.

13. The UE of claim 12, wherein the one or more processors are individually or collectively further operable to execute the code to cause the UE to:
obtain an indication that a set of periodic burst transmissions associated with a data flow are consumed by the application server at a set of periodic delivery deadlines, the set of periodic burst transmissions comprising the first periodic burst transmission, and the set of periodic delivery deadlines comprising the first delivery deadline.

14. The UE of claim 12, wherein the one or more processors are individually or collectively further operable to execute the code to cause the UE to:
output an indication of the jitter window and an indication of a burst arrival time associated with the first periodic burst transmission; and
obtain a configured grant based at least in part on the jitter window and the burst arrival time, wherein outputting the first periodic burst transmission is based at least in part on the configured grant.

15. The UE of claim 12, wherein the one or more processors are individually or collectively further operable to execute the code to cause the UE to:
output an indication of a delay status report value associated with the first periodic burst transmission, wherein the delay status report value indicates the one or more PDU sets arrived at a transmission buffer of the UE after buffering the one or more PDU sets.

16. The UE of claim 12, wherein the one or more processors are individually or collectively further operable to execute the code to cause the UE to:
estimate the jitter window associated with the first periodic burst transmission based at least in part on a reference table and communication conditions.

17. The UE of claim 16, wherein the one or more processors are individually or collectively further operable to execute the code to cause the UE to:
measure a plurality of jitter windows and a corresponding plurality of communication conditions associated with communication of a plurality of periodic burst transmissions, the plurality of periodic burst transmissions being prior to the first periodic burst transmission, wherein the reference table is based at least in part on the plurality of jitter windows and the corresponding plurality of communication conditions.

18. The UE of claim 12, wherein the one or more processors are individually or collectively further operable to execute the code to cause the UE to:
measure a duration associated with generating the one or more PDU sets of the first periodic burst transmission; and
estimate the jitter window based at least in part on the duration associated with generating the one or more PDU sets.

19. The UE of claim 12, wherein the one or more processors are individually or collectively further operable to execute the code to cause the UE to:
measure one or more jitter windows associated with communication of one or more periodic burst transmissions, the one or more periodic burst transmissions being prior to the first periodic burst transmission;
measure a duration associated with generating the one or more PDU sets of the first periodic burst transmission; and
estimate the jitter window based at least in part on the duration associated with generating the one or more PDU sets, a reference table, and communication conditions.

20. A method for wireless communications at a wireless device, comprising:
generating one or more packet data unit (PDU) sets of a first periodic burst transmission during a jitter window, the first periodic burst transmission corresponding to a first delivery deadline at an application server, the jitter window spanning a time period prior to or after a first arrival time associated with the one or more PDU sets;
buffering the one or more PDU sets for a first duration of the jitter window, wherein the first duration corresponds to a threshold percentage of the jitter window; and
outputting the one or more PDU sets based at least in part on expiration of the first duration and prior to the first delivery deadline.
